(19) United States
(12) Patent Application Publication
(10) Pub. No.: US 2017/0373949 A1
(43) Pub. Date: Dec. 28, 2017

(54) CONTROL APPARATUS, TESTING METHOD, COMMUNICATION SYSTEM, AND NON-TRANSITORY COMPUTER-READABLE STORAGE MEDIUM

(71) Applicant: FUJITSU LIMITED, Kawasaki-shi (JP)

(72) Inventors: Tomoya FURUICHI, Kawasaki (JP); Jo SUGINO, Yokohama (JP)

(73) Assignee: FUJITSU LIMITED, Kawasaki-shi (JP)

(21) Appl. No.: 15/621,193

(22) Filed: Jun. 13, 2017

(30) Foreign Application Priority Data
Jun. 27, 2016 (JP) 2016-126376

(51) Int. Cl. H04L 12/26; H04L 29/06

(52) U.S. Cl. CPC H04L 43/022; H04L 63/1425; H04L 43/50; H04L 43/045; H04L 43/0811; H04L 43/106

(57) ABSTRACT

A control apparatus executes configuration processing that includes applying filters for blocking input and output of a test packet to ports associated with the packet forwarding devices, except for one or more ports on an assumed forwarding route in a section targeted for a forwarding status determination and configuring the packet forwarding device located at an end port of the section so that the test packet that arrives at the end port is forwarded to the control apparatus, executes communication processing that includes transmitting the test packet from the communication circuit to a start port of the section, and executes determination processing that includes determining that packet forwarding is performed normally in the section, upon receipt of the test packet via the communication circuit after the transmission of the test packet.

### CROSS-REFERENCE TO RELATED APPLICATION

This application is based upon and claims the benefit of priority of the prior Japanese Patent Application No. 2016-126376, filed on Jun. 27, 2016, the entire contents of which are incorporated herein by reference.

### FIELD

The embodiments discussed herein are related to a control apparatus, a testing method, a communication system, and a non-transitory computer-readable storage medium.

### BACKGROUND

To determine whether a network is operating normally, a connectivity check may be conducted on a determination target area by causing devices in the network to transmit and receive a test packet.

FIG. 1 is a diagram illustrating an example of a connectivity check. The network depicted in FIG. 1 as a case C1 includes switches SW0 to SW6, a communication device 10a, a communication device 10b, a processing device 5a, and a processing device 5b. The communication devices 10 transmit and receive packets, and the processing devices 5 process packets upon receipt of the packets. In the case C1, the switches SW1 to SW6 are connected to the switch SW0. The communication device 10a is connected to the switch SW1, and the communication device 10b is connected to the switch SW6. Further, the processing device 5a is connected to the switch SW2 and the switch SW3, and the processing device 5b is connected to the switch SW4 and the switch SW5. The diamonds in FIG. 1 each indicate a port used by a certain switch to connect to another switch, and the number in each diamond indicates the number assigned to that port. The switch SW0 is assumed to perform forwarding processing in the directions denoted by the arrows. Specifically, the switch SW0 in this example is assumed to receive a packet through the port 3 and output the packet through the port 4, receive a packet through the port 9 and output the packet through the port 10, and receive a packet through the port 15 and output the packet through the port 16.

To check the connectivity of a route from the switch SW1 to the switch SW2, a test control apparatus 2 sets a virtual port used for testing (port test, PT) at the switch SW2. After that, the test control apparatus 2 outputs a test packet P1 to the port 1 of the switch SW1 and determines whether the test control apparatus 2 receives the test packet P1 back from the test port. By receiving the test packet P1 from the test port, the test control apparatus 2 is able to confirm the connectivity from the switch SW1 to the switch SW2, but there is more than one possible forwarding route that the test packet could have taken. In other words, the test packet could have been forwarded via the route denoted by arrow A in the case C1, or could have been forwarded via a different route. For example, assume that filters (test packet filters) are applied to the port 1 of the switch SW1 and the port 18 of the switch SW6 to block output of a test packet through those ports. In such a case, the test packet P1 could have been forwarded via the route denoted by arrow B in a case C2. Thus, the test packet inputted to the switch SW1 through the port 1 and then to the switch SW0 through the port 3 could have been outputted from the switch SW0 through the port 10, and then outputted to the switch SW2 via the switch SW4, the processing device 5b, the switch SW5, and then the switch SW0. Hence, when it is requested to check whether a packet traverses multiple switches in an assumed order, the connectivity check is insufficient, as described with reference to FIG. 1. For example, management of a network which uses software-defined networking (SDN) may ask for a check on whether a packet traverses virtual switches and the like in an assumed order, because packet forwarding routes are controlled dynamically in the SDN network.

As a related art, a test control apparatus is known, which controls testing devices distributed in a network and thereby tests the connectivity of a flow of communication that passes through a processing device configured to perform processing designated by a user. The test control apparatus causes a first testing device to transmit a test packet to a first communication device, which is connected to the testing device and upstream of the processing device, and through which the flow passes. Then, from a second communication device which is downstream of the processing device and through which the flow passes, the test control apparatus acquires information on whether the test packet has been received by the second communication device. Examples of the related art include Japanese Laid-open Patent Publication No. 2015-154252.

### SUMMARY

According to an aspect of the invention, a control apparatus that controls a plurality of packet forwarding devices includes: a communication circuit configured to communicatively couple to the packet forwarding devices over a network; and a processor coupled to the communication circuit and configured to execute configuration processing that includes applying filters for blocking input and output of a test packet to ports associated with the packet forwarding devices, except for one or more ports on an assumed forwarding route in a section targeted for a forwarding status determination, the section starting at a start port which is the port of the packet forwarding device located at a start of the section and ending at an end port which is the port of the packet forwarding device located at an end of the section, and configuring the packet forwarding device located at the end port so that the test packet that arrives at the end port is forwarded to the control apparatus, execute communication processing that includes transmitting the test packet from the communication circuit to the start port, and execute determination processing that includes determining that packet forwarding is performed normally in the section, upon receipt of the test packet via the communication circuit after the transmission of the test packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a connectivity check;

FIG. 2 is a diagram illustrating an example of a communication method according to an embodiment;

FIG. 3 is a diagram illustrating an example configuration of a control apparatus;

FIG. 4 is a diagram illustrating an example hardware configuration of the control apparatus;

FIG. 5 is a diagram illustrating an example of a physical network;

FIG. 6 is a diagram illustrating an example of a logical network and a forwarding route;

FIG. 7 is a diagram illustrating an example of information retained by the control apparatus;

FIG. 8 is a diagram illustrating an example of processing for checking the connectivity of a forwarding route from a switch SW1 to a switch SW2;

FIG. 9 is a diagram illustrating an example of a test packet;

FIG. 10 is a diagram illustrating an example of processing for checking the connectivity of a forwarding route from the switch SW1 to a switch SW4;

FIG. 11 is a diagram illustrating an example of processing for checking the connectivity of a forwarding route from the switch SW1 to a switch SW6;

FIG. 12 is a flowchart illustrating an example of network configuration processing;

FIG. 13 is a flowchart illustrating an example of a connectivity check test;

FIG. 14 is a diagram illustrating an example of a test result;

FIG. 15 is a flowchart illustrating an example of processing for canceling settings configured for testing;

FIG. 16 is a diagram illustrating an example of processing for checking the connectivity of a forwarding route from the switch SW6 to the switch SW5;

FIG. 17 is a diagram illustrating an example of processing for checking the connectivity of a forwarding route from the switch SW6 to the switch SW3;

FIG. 18 is a diagram illustrating an example of processing for checking the connectivity of a forwarding route from the switch SW6 to the switch SW1;

FIG. 19 is a diagram illustrating an example of a network failure;

FIG. 20 is a diagram illustrating an example of processing for specifying the location of the failure;

FIG. 21 is a diagram illustrating an example of processing for checking the connectivity of a forwarding route from the switch SW1 to the switch SW3;

FIG. 22 is a diagram illustrating an example of processing for specifying the location of a failure; and

FIG. 23 is a flowchart illustrating an example of processing for performing a connectivity check on each target area while expanding the target area by one adjacent switch.

### DESCRIPTION OF EMBODIMENTS

As explained in the BACKGROUND section, it is difficult to confirm if a packet has traversed multiple switches in an assumed order. A conceivable way to confirm that a test packet is forwarded via an assumed route is to collect trace logs at the respective switches in the network and analyze the trace logs, in addition to conducting the connectivity check using a test packet. However, time stamps on trace logs are not accurate enough to help find out the order in which the test packet has traversed the switches. Such a problem occurs not only when the switches used for packet exchange are physical switches, but also when they are virtual ones.

As one aspect of the present embodiments, provided are solutions for being able to determine whether a packet traverses switches in an assumed order.

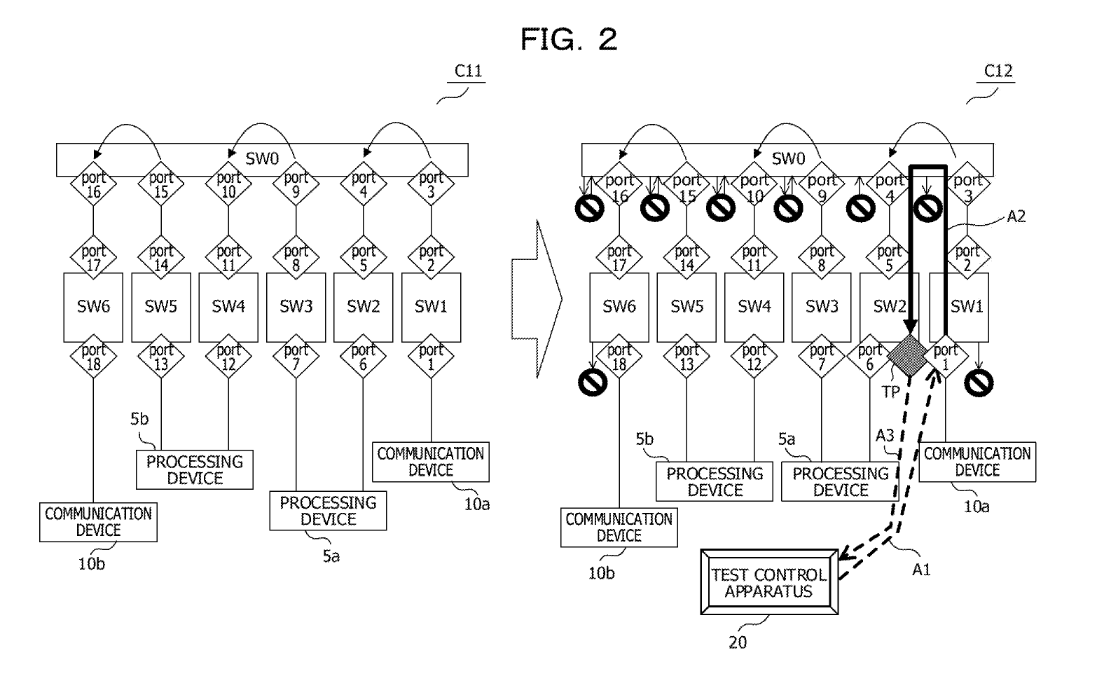

FIG. 2 is a diagram illustrating an example of a communication method according to an embodiment. A control apparatus 20 according to the embodiment applies filters to switches to block packet input and output which are not to be performed if a test packet is forwarded via an expected forwarding route from the start port to the end port of an area to be checked for connectivity. This “area” is a section of an expected packet forwarding route and is to be tested whether a packet is forwarded via the assumed route.

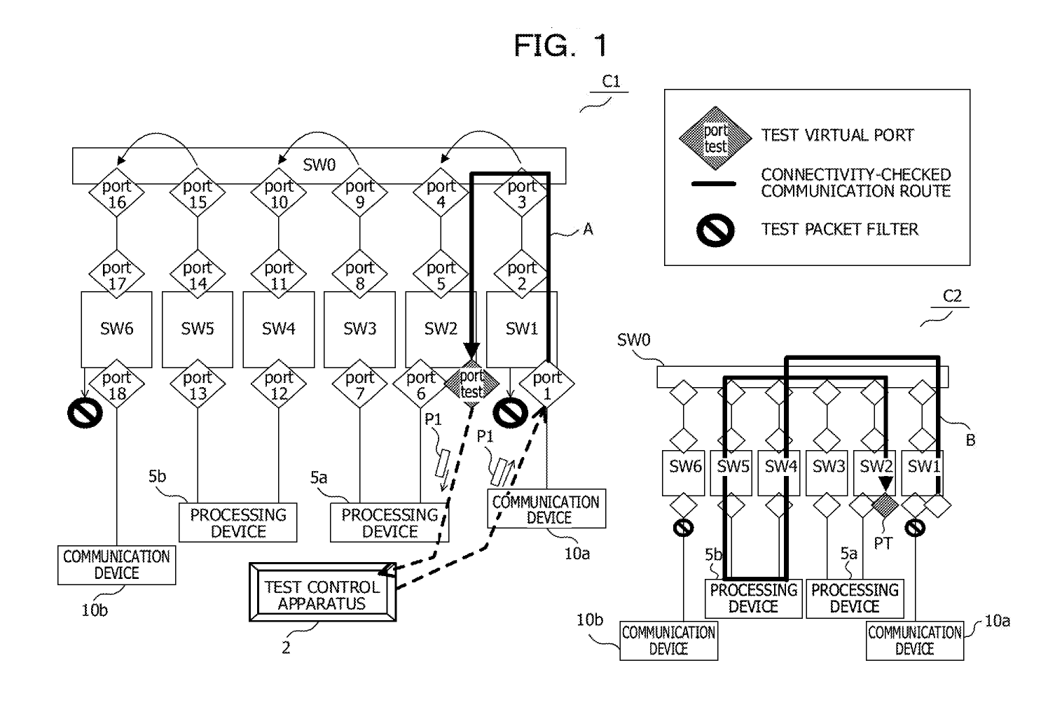

In a network depicted in a case C11, switches SW0 to SW6, a communication device 10a, a communication device 10b, a processing device 5a, and a processing device 5b are connected in a manner similar to the network described with reference to the case C1 in FIG. 1. Herein, the processing device 5a, 5b is, for example, a firewall, an intrusion prevention system/intrusion detection system (IPS/IDS), or a unified threat management (UTM) system.

The following describes an example of checking the connectivity of a test-packet forwarding route in the area from the switch SW1 to the switch SW2 in the network of the case C11. Assume that, on the forwarding route expected in this example, a packet is inputted to the switch SW1 through a port 1, outputted from the switch SW1 through a port 2, inputted to the switch SW0 through a port 3, outputted from the switch SW0 through a port 4, and then inputted to the switch SW2 through a port 5. If the test packet is forwarded via this assumed forwarding route, ports 9, 10, 15, and 16 of the switch SW0 are used for neither input nor output of the test packet. In other words, these ports are not on the assumed forwarding route.

Thus, as depicted in a case C12, the control apparatus 20 applies filters to the ports 9, 10, 15, and 16 of the switch SW0 to block both input and output of a test packet through these ports. If a test packet is forwarded via the assumed forwarding route, the test packet is not to be outputted from the port 3 of the switch SW0 and not to be inputted into the port 4 of the switch SW0. Thus, the control apparatus 20 also applies a filter to the port 3 of the switch SW0 to block output of a test packet through the port 3, and also applies a filter to the port 4 of the switch SW0 to block input of a test packet through the port 4. Additionally, as depicted in the case C12, the control apparatus 20 may apply a filter to the port 1 of the switch SW1 to block output of a test packet through the port 1 and a filter to a port 18 of the switch SW6 to block output of a test packet through the port 18.

After thus applying the filters, the control apparatus 20 outputs a test packet to the port 1 of the switch SW1 (see arrow A1). In the example in FIG. 2, the test packet inputted to the switch SW1 through the port 1 is outputted from the switch SW1 through the port 2, and is inputted to the switch SW0 through the port 3. The switch SW0 receives the test packet because no filter is applied to the port 3 to block input of test packets, and outputs the test packet through the port 4. Since no filter is applied to the port 4 to block output of test packets, the test packet arrives at the port 5 of the switch SW2 (see arrow A2). The test packet is outputted from the port 5 to the control apparatus 20 through a test port (TP) (see arrow A3).

When a test packet is to be inputted to or outputted from a port to which a filter is applied to block the input or output, the test packet is dropped at the port. For example, if a test packet is to be outputted from the switch SW0 through the port 3, the test packet is dropped by the effect of the test-packet filter applied to the port 3. A test packet is dropped similarly at the other ports with the filters, so that the test packet will not reach the test port by traversing a device not on the assumed forwarding route.

Hence, upon receipt of the test packet as indicated by arrow A3, the control apparatus 20 determines that the test packet has been forwarded in the expected forwarding route in the area from the switch SW1 to the switch SW2 (see arrow A2).

In the method according to the embodiments, a test packet to be forwarded via an expected forwarding route from the start port to the end port of an area to be checked for connectivity is blocked from being inputted to or outputted from the ports not on the expected forwarding route. Thus, in addition to being able to check connectivity, the method is able to determine if the test packet has been forwarded via the expected forwarding route. In the method according to the methods, the switches on the routes may be physical switches or virtual switches, and the ports of the switches to which filters are applied may be physical ports or virtual ports, although they are not distinguished as to whether they are virtual or physical in the example in FIG. 2.

<Configuration of the Apparatus>

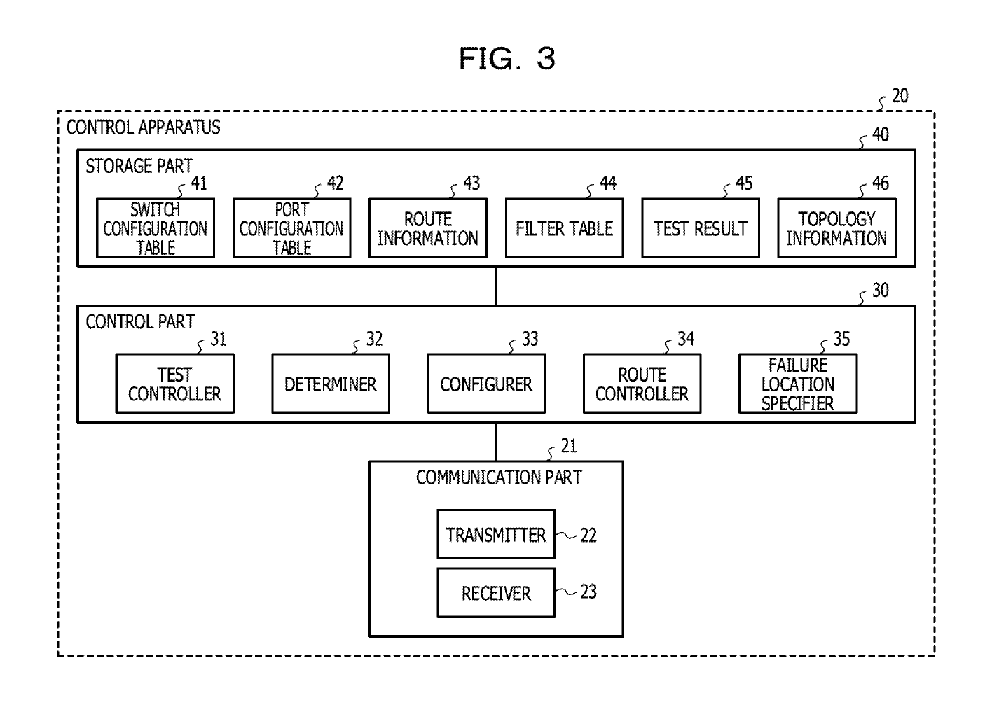

FIG. 3 is a diagram illustrating an example configuration of the control apparatus 20. The control apparatus 20 may be implemented as an SDN controller. The control apparatus 20 includes a communication part 21, a control part 30, and a storage part 40. The communication part 21 has a transmitter 22 and a receiver 23. The control part 30 has a test controller 31, a determiner 32, a configurer 33, a route controller 34, and optionally, a failure location specifier 35. The storage part 40 stores therein a switch configuration table 41, a port configuration table 42, route information 43, a filter table 44, a test result 45, and topology information 46.

The switch configuration table 41 associates the input port and the output port of each switch which are used to forward a packet. The port configuration table 42 identifies a source device and its one-hop destination device to which a packet from the source device is forwarded. Thus, using both the switch configuration table 41 and the port configuration table 42, information on an assumed route to the destination to forward a test packet is identifiable. The assumed route is stored as the route information 43. Specific examples of the switch configuration table 41 and the port configuration table 42 will be given later. The topology information 46 provides information on the connections among the devices in the network.

The transmitter 22 transmits a packet to a device such as a switch. The receiver 23 receives a packet from a device such as a switch. The test controller 31 controls the processing performed by the determiner 32 and the configurer 33 to make a determination on the entire route by conducting a test on each divided area of the route. The configurer 33 applies the test-packet filters using the switch configuration table 41 and the port configuration table 42 as appropriate. The configurer 33 stores information on the applied filters in the storage part 40, as the filter table 44. The route controller 34 determines a packet forwarding route using the topology information 46 and generates the route information 43 indicative of the packet forwarding route. The determiner 32 determines whether forwarding processing has been performed normally in the tested area, and stores the obtained determination result as the test result 45.

When the determination result on connectivity indicates that the network has a failure, the failure location specifier 35 performs processing for specifying the location of the failure. When specifying the location of the failure, the failure location specifier 35 generates an analysis result containing information on the location of the failure, and outputs the result so that the operator may be aware of the result.

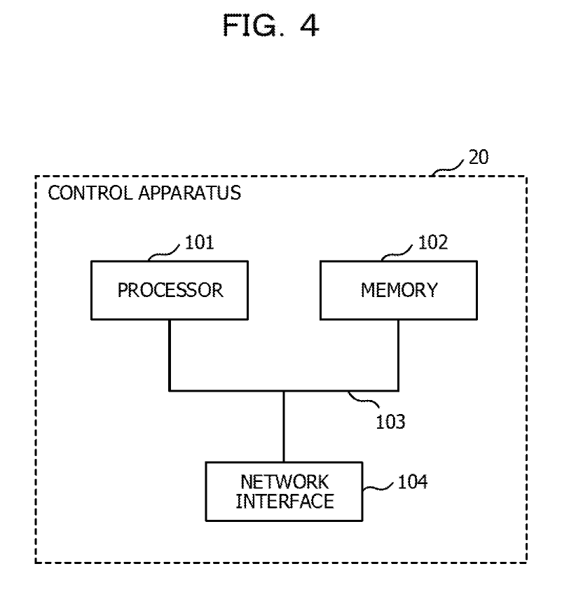

FIG. 4 is a diagram illustrating an example hardware configuration of the control apparatus 20. The control apparatus 20 includes a processor 101, a memory 102, buses 103, and a network interface 104. The processor 101 may be any processing circuit, such as a central processing unit (CPU). The memory 102 includes a random access memory (RAM) and a read-only memory (ROM). The processor 101 executes programs stored in the memory 102. The buses 103 connect the processor 101, the memory 102, and the network interface 104 to one another to enable them to exchange data. The network interface 104 is used for input and output of information to and from the devices in the network. The network interface 104 is implemented as, for example, a network interface card (NIC). In the control apparatus 20, the processor 101 operates as the control part 30, the memory 102 operates as the storage part 40, and the network interface 104 implements the communication part 21.

Optionally, the control apparatus 20 may have at least one of an input device, an output device, and a portable storage-medium drive device. The input device is any device used to input information, such as a keyboard, and the output device is any device used to output data, such as a display. The portable storage-medium drive device is capable of outputting data in the memory 102 to a portable storage medium and of reading programs, data, and the like from a portable storage medium. The portable storage medium is any storage medium which is portable.

### First Embodiment

An example of processing performed in a first embodiment is described below, in order of “Descriptions about Example Network and Assumed Forwarding Route”, “Tests for Checking Connectivity”, “Evaluation of Test Results”, and “Test Ending Processing”.

(1) Descriptions about Example Network and Assumed Forwarding Route

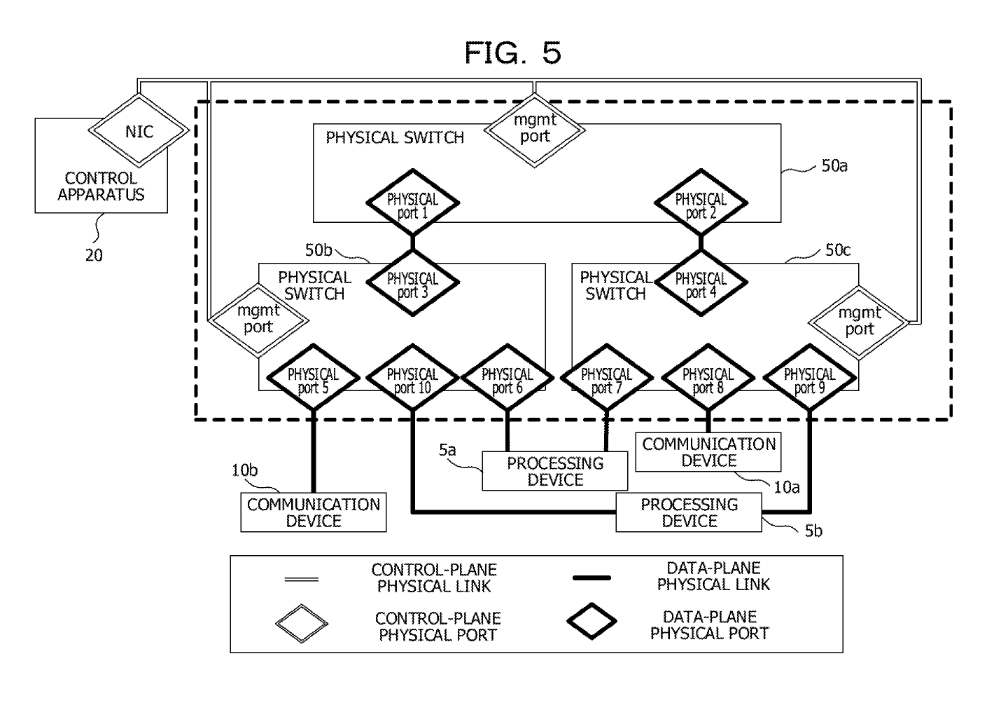

FIG. 5 is a diagram illustrating an example physical network to which the first embodiment is applicable. The physical network depicted in FIG. 5 includes the control apparatus 20, physical switches 50 (50a to 50c), communication devices 10 (10a, 10b), and processing devices 5 (5a, 5b). The control apparatus 20 is connected to each of the physical switches 50a to 50c via a NIC. The physical switches 50a to 50c are connected to the control apparatus 20 via their respective control-plane physical ports (mgmt ports). The physical switch 50b is connected to the physical switch 50a, and the physical switch 50c is also connected to the physical switch 50a. A physical port 1 of the physical switch 50a is connected to a physical port 3 of the physical switch 50b. A physical port 2 of the physical switch 50a is connected to a physical port 4 of the physical switch 50c.

The physical switch 50b is connected to the communication device 10b via a physical port 5. The physical switch 50b is connected to the processing device 5a via a physical port 6 and to the processing device 5b via a physical port 10. The physical switch 50c is connected to the communication device 10a via a physical port 8. The physical switch 50c is connected to the processing device 5a via a physical port 7 and to the processing device 5b via a physical port 9.

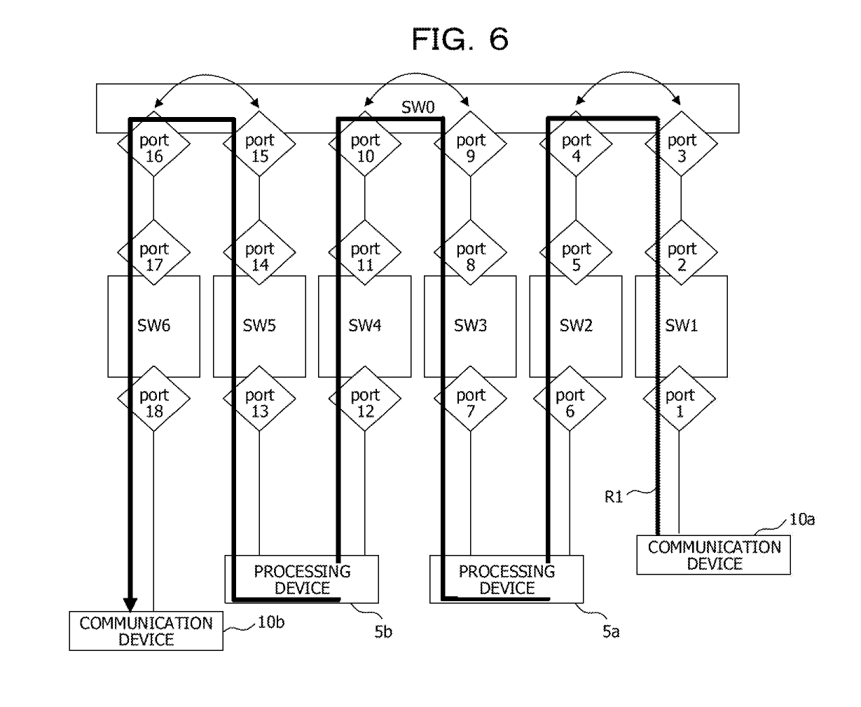

FIG. 6 is a diagram illustrating an example logical network and an example forwarding route. It is assumed in the first embodiment that the logical network depicted in FIG. 6 is implemented using the physical network in FIG. 5. The switches SW0 to SW6 are all virtual switches. Hereinbelow, virtual switches may be simply called “switches”. Each of the virtual switches is controlled by the control apparatus 20, and performs processing according to the settings configured by the control apparatus 20.

In the first embodiment, the switch SW0 is implemented by the physical switch 50a. The switches SW1, SW3, and SW5 are implemented by the physical switch 50c, and the switches SW2, SW4, and SW6 are implemented by the physical switch 50b. Thus, the physical port 1 of the switch SW0 operates as a logical port 4, a logical port 10, and a logical port 16, while the physical port 2 of the switch SW0 operates as a logical port 3, a logical port 9, and a logical port 15. Similarly, the physical port 3 of the physical switch 50b operates as a logical port 5, a logical port 11, and logical port 17, while the physical port 4 of the physical switch 50c operates as a logical port 2, a logical port 8, and a logical port 14. As to the physical switch 50c, the physical port 8 operates as a logical port 1, the physical port 7 operates as a logical port 7, and the physical port 9 operates as a logical port 13. As to the physical switch 50b, the physical port 5 operates as a logical port 18, the physical port 6 operates as a logical port 6, and the physical port 10 operates as a logical port 12. Hereinbelow, the logical ports may be simply called “ports”.

In the example described below, the switch SW0 operates as a flow switch, and the switches SW1 to SW6 operate as fabric switches. The flow switch forwards packets between the virtual switches operating as the fabric switches. Each fabric switch forwards packets between the flow switch and the communication device 10 or the processing device 5 connected to the fabric switch. In the example in FIG. 6, the switch SW0 is configured to forward packets between the port 3 and the port 4, between the port 9 and the port 10, and between the port 15 and the port 16.

In the network in FIG. 6, the assumed communication route is a route R1 that runs from the communication device 10a to the communication device 10b via the processing device 5a and the processing device 5b. Specifically, as a result of route computation using the topology information 46 and the like, the route controller 34 of the control apparatus 20 has determined the forwarding route R1 for a packet transmitted from the communication device 10a toward the communication device 10b. In this case, the route R1 is the assumed route from the communication device 10a to the communication device 10b. The processing device 5a and the processing device 5b are provided in the network to perform security processing and the like. The processing device 5a is configured, in advance, to forward a packet received from the switch SW2 to the switch SW3, while the processing device 5b is configured, in advance, to forward a packet received from the switch SW4 to the switch SW5.

In the case described below, the route controller 34 configures the switches SW0 to SW6 so that the switches SW0 to SW6 will forward a packet either via the route R1 or in the reverse direction of the route R1, irrespective of the destination or source of the packet. For example, assume that the control apparatus 20 configures the switches using OpenFlow. Then, as a match condition, an input port is designated, but address information is not. To be more specific, as the match condition, wildcards are used for a packet's destination internet protocol (IP) address, source IP address, source media access control (MAC) address, and destination MAC address. As an action for the match condition, an action of outputting a packet and a port used for the output are designated. For example, packet processing rules defined by the route controller 34 for the switch SW1 are as follows.

Processing Rule 1

input port=virtual port 1 Match Condition 1:

Action: Output packet that satisfies Match Condition 1 through virtual port 2.

Processing Rule 2

input port=virtual port 2 Match Condition 2:

Action: Output packet that satisfies Match Condition 2 through virtual port 1.

Route information set by the route controller 34, such as information on the route R1, is stored in the storage part 40 as the route information 43 as appropriate.

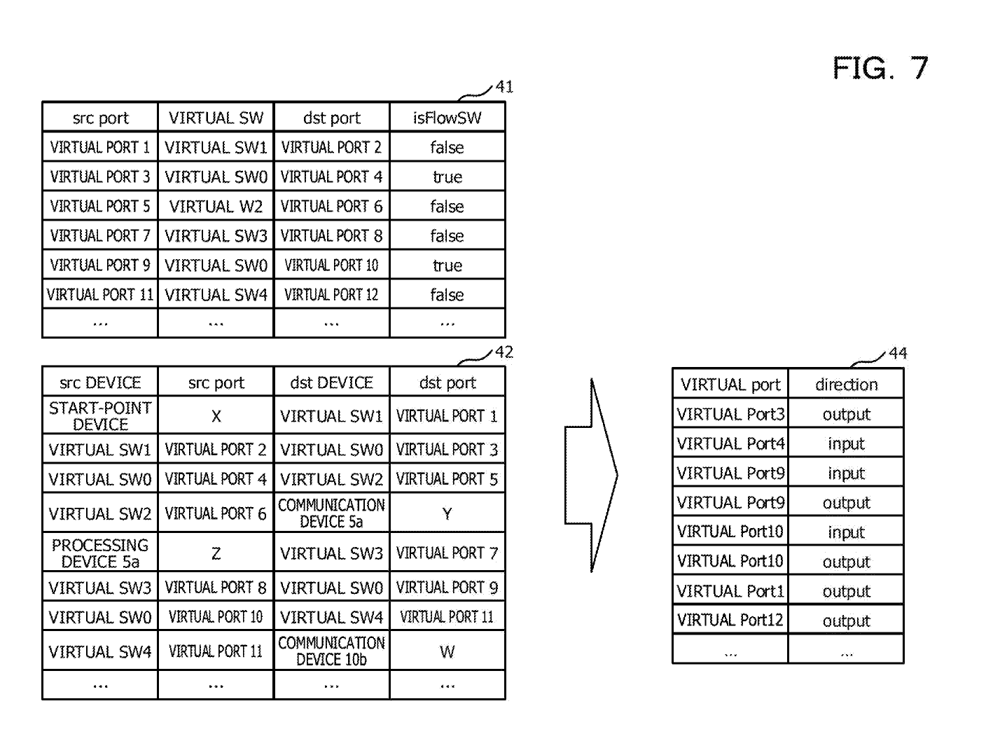

FIG. 7 is a diagram illustrating an example of information retained by the control apparatus 20. The route controller 34 generates the switch configuration table 41 and the port configuration table 42 based on the route determined. The switch configuration table 41 contains information indicating forwarding processing to be performed by each switch to forward a packet via the assumed forwarding route and information indicating whether the switch is a flow switch. The port configuration table 42 contains information indicating a forwarding route to be taken by a packet from one switch or device to another to forward the packet via the assumed forwarding route. As described with reference to FIG. 6, the route controller 34 configures each switch so that the switch determines the output port for a packet based not on the destination of the packet or the like, but on the port through which the packet has been inputted. For this reason, the information in the switch configuration table 41 and the port configuration table 42 applies to every packet irrespective of the address in the packet, unless other settings such as filtering are made.

The switch configuration table 41 in FIG. 7 is an example of information set when the route depicted in FIG. 6 is the assumed route (some pieces of information are omitted from FIG. 7 for easy viewing). Each entry of the switch configuration table 41 includes “src port”, “virtual switch”, “dst port”, and “isFlowSW” flag. On an entry for a certain virtual switch, “src port” provides information on the port of the virtual switch from which a packet is to be inputted; “dst port” provides information on the port of the virtual switch through which a packet inputted through the port identified by “src port” is to be outputted; “isFlowSW” flag provides information indicating whether the virtual switch is a flow switch. The switch of the entry is not a flow switch when the isFlowSW flag is “false”, and the switch of the entry is a flow switch when the isFlowSW flag is “true”.

For example, in the first entry of the switch configuration table 41, the output destination of a packet inputted to the virtual switch SW1 through the virtual port 1 is set to the virtual port 2. Thus, if the switch SW1 is operating according to the configured setting, a packet inputted to the virtual switch SW1 through the virtual port 1 is outputted from the virtual switch SW1 through the virtual port 2. The isFlowSW flag is set to “false” for this entry because the virtual switch SW1 does not operate as a flow switch. In the second entry, it is recorded that a packet inputted to the virtual switch SW0 through the virtual port 3 is outputted from the virtual switch SW0 through the virtual port 4. Thus, if the switch SW0 is operating according to the configured setting, a packet inputted to the virtual switch SW0 through the virtual port 3 is outputted from the switch SW0 through the virtual port 4. The isFlowSW flag is set to “true” for the second entry because the virtual switch SW0 operates as a flow switch.

The port configuration table 42 in FIG. 7 is an example of information set when the route depicted in FIG. 6 is the assumed route (some pieces of information are omitted from FIG. 7 for easy viewing). Each entry of the port configuration table 42 includes “src device”, “src port”, “dst device”, and “dst port”. The item “src device” provides information on a device on the forwarding route from which a packet is forwarded, and “src port” provides identification information on the port used by this source device to output the packet. The item “dst device” provides information on a device on the forwarding route to which the packet is forwarded, and “dst port” provides identification information on the port used by this destination device to receive the packet. Thus, a packet is inputted from the src port of the switch designated to be the src device to the dst port of the switch designated to be the dst device.

For example, in the first entry of the port configuration table 42, it is recorded that a packet is forwarded from a port X of the communication device 10a to the virtual port 1 of the virtual switch SW1. Thus, if the forwarding processing is performed according to the configured setting, a packet outputted from the communication device 10a through the port X arrives at the virtual port 1 of the virtual switch SW1. Similarly, in the second entry, it is recorded that a packet is forwarded from the virtual port 2 of the virtual switch SW1 to the virtual port 3 of the virtual switch SW0. Thus, if the forward processing is performed according to the configured setting, a packet outputted from the virtual switch SW1 through the virtual port 2 arrives at the virtual port 3 of the virtual switch SW0.

(2) Tests for Checking Connectivity

Next, a description is given of an example of how connectivity tests are performed using the switch configuration table 41 and the port configuration table 42 having information as depicted in FIG. 7. From a terminal (not depicted in the drawings) manipulated by an operator, the receiver 23 of the control apparatus 20 receives a request for a test for checking the connectivity of the route R1. The receiver 23 outputs the request for the connectivity check test, to the test controller 31.

The test controller 31 identifies the route for which the connectivity check test is requested, and then defines a tested area in the route by applying filters to the flow switch, so that only one route is possible in the tested area. In this regard, the test controller 31 sets the start port of the tested area to the port that receives a packet from the communication device 10 where the route starts. The test controller 31 sets the end port of the tested area so that forwarding processing at the flow switch for which it is yet to be determined whether the forwarding processing is performed according to the configured setting may not be performed more than once. When the end port is set in such a manner, it is possible to determine whether the flow switch performs the assumed forwarding processing and to keep a packet from being forwarded via an unexpected route.

For example, to test the route R1 depicted in FIG. 6, the test controller 31 sets the start port for the test to the port 1 of the switch SW1. Since none of the forwarding pairs of the ports of the switch SW0 operating as the flow switch has been checked whether forward processing between the pair is performed according to the configured setting, the test controller 31 determines that the tested area includes forwarding processing from the port 3 to the port 4 of the switch SW0 to determine whether the forward processing is performed according to the configured setting. Thus, the test controller 31 sets the end port of the tested area to the port 5 of the switch SW2. The test controller 31 notifies the configurer 33 and the determiner 32 that the tested area is from the port 1 of the switch SW1 to the port 5 of the switch SW2.

Upon acquisition of the information indicating the area for the packet connectivity test, the configurer 33 determines, using the switch configuration table 41 and the port configuration table 42, ports to apply filters for the connectivity test and the directions (input or output) blocked by the filters on the ports. In this regard, the configurer 33 determines to block all the input and output which are not to be performed if a test packet is forwarded from the start port to the end port of the tested area via the forwarding route to be checked for the connectivity. The configurer 33 records the thus-determined filtering information on the filter table 44. Each entry of the filter table 44 has a virtual port to which a filter for a test packet is applied and the direction in which the test packet is filtered.

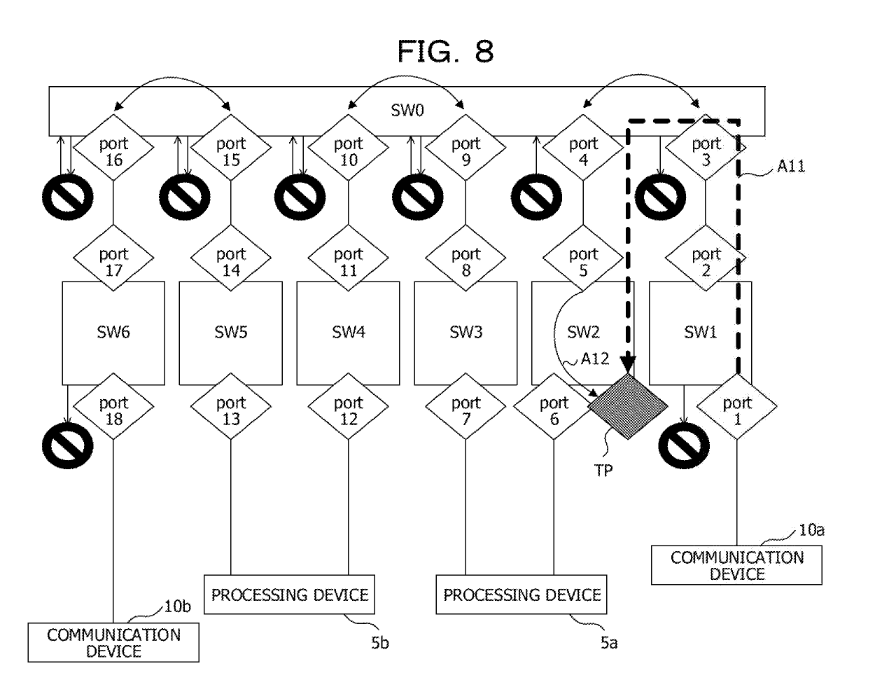

The filter table 44 depicted in FIG. 7 provides information on some of the filters which are applied when the tested area is from the port 1 of the switch SW1 to the port 5 of the switch SW2. With reference to FIG. 8, a description is given of filter application processing using the filter table 44.

FIG. 8 is a diagram illustrating an example of processing for checking the connectivity of the forwarding route in the area from the switch SW1 to the switch SW2. Broken-line arrow A11 in FIG. 8 is the tested area of the route R1. In FIG. 8, on the left of each port to which a filter is applied according to the filter table 44 generated in FIG. 7, a symbol representing a test-packet filter is depicted with an arrow pointing out or to the symbol to indicate the forwarding direction in which a test packet is filtered. For instance, in the switch SW0, all the paths for forwarding a test packet except for one from the port 3 to the port 4 are invalidated. Thus, in the switch SW0, output of a test packet through the port 3 and input of a test packet through the port 4 are blocked by the filters. In addition, both input and output of a test packet to and from the ports 9, 10, 15, and 16 of the switch SW0 are blocked by the filters. To keep a test packet from being outputted to the communication device 10a and the communication device 10b, a filter for blocking output of a test packet from the port 1 of the switch SW1 and a filter for blocking output of a test packet from the port 18 of the switch SW6 are also applied.

Moreover, the configurer 33 sets a test port through which a test packet arriving at the end port is to be forwarded from the end port to the control apparatus 20. The test port is set at the switch having the end port. Since the port 5 is the end port in FIG. 8, the configurer 33 sets a test port (TP) at the switch SW2 having the port 5. The configurer 33 configures a setting so that the end port will forward a test packet to the test port. Arrow A12 depicts the route via which the test packet is forwarded from the port 5, which is the end port, to the test port.

The configurer 33 configures the test-packet filtering settings and test-packet forwarding setting described above with reference to FIG. 8 so that these settings may not be applied to packets other than test packets. To this end, the configurer 33 uses address information on a test packet when configuring the settings such as filtering for input and output at each port.

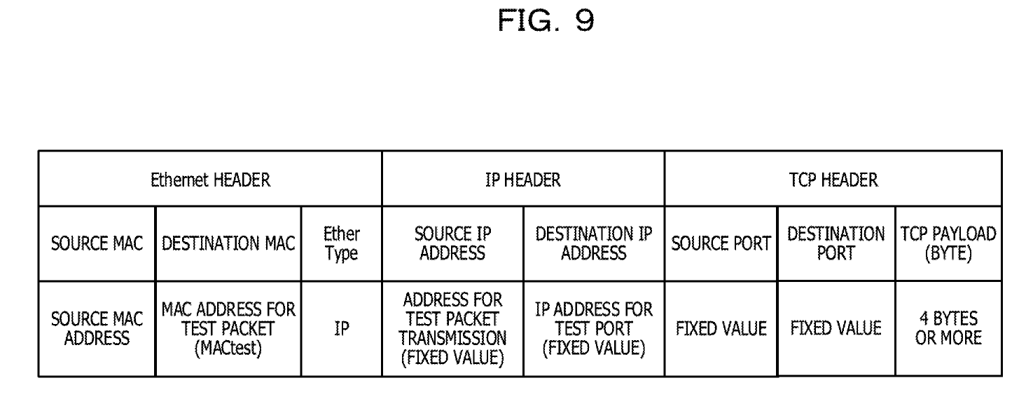

FIG. 9 is a diagram illustrating an example of a test packet. The test packet depicted in FIG. 9 is for a case where the transmission control protocol (TCP) and IP version 4 (IPv4) are used. The test packet contains an Ethernet header, an IP header, and a TCP header. The Ethernet header contains a source MAC address, a destination MAC address, and an EtherType. The EtherType is a value indicative of the type of the upper protocol, which is, in the example in FIG. 9, a value indicating IPv4 (0x0800). The source MAC address is a MAC address allocated to the control apparatus 20 transmitting the test packet. As the destination MAC address, a fixed value for test packets is set. The MAC address for test packets is used as a MAC address allocated to the test port to which the test packet is to be sent. The MAC address for test packets may be a virtual MAC address assigned to the test port. Each switch and the control apparatus 20 identifies the test packet based on the destination MAC address.

In the IP header, a source IP address and a destination IP address are set. The destination IP address is the IP address allocated to the test port. The source IP address is the IP address used by the control apparatus 20 for transmission of the test packet. The TCP header contains a source port number, a destination port number, and a TCP payload. Any preset fixed values are used as the source port number and the destination port number. The TCP payload contains data of four bites or more, in which padding may be used according to the implementation.

Since the switches and the control apparatus 20 identify a packet as a test packet based on its destination MAC address, the configurer 33 uses the destination MAC address to apply test-packet filters. For instance, if “MACtest” is used as the MAC address for test packets, the configurer 33 may configure the switch SW0 as follows.

Processing Rule 1

destination MAC address=MACtest, and input port=virtual port 3 Condition 1:

Action: Output packet that satisfies Condition 1 through virtual port 4.

Processing Rule 2

destination MAC address=MACtest, and input port=virtual port 4, 9, 10, 15, or 16 Condition 2:

Action: Not receive but drop packet that satisfies Condition 2.

Processing Rule 3

destination MAC address=MACtest, and output port=virtual port 3, 9, 10, 15, or 16 Condition 3:

Action: Not transmit but drop packet that satisfies Condition 3.

The setting for forwarding a test packet from the end port to the test port (hereinafter referred to as test-packet forwarding setting) is also configured using the value of the destination MAC address of the test packet. For instance, the configurer 33 configures the switch SW2 as follows.

destination MAC address=MACtest, and input port=virtual port 5 Condition:

Action: Output packet that satisfies the above condition through the test port TP.

The test port TP is connected to the control apparatus 20 in this example. The example processing rules 1 to 3 defined by the configurer 33 for the switch SW0 concern test packets only, and do not apply to packets other than test packets. Thus, during a connectivity test, packets other than test packets are forwarded via the route defined in the switch configuration table 41 and the port configuration table 42 in FIG. 7.

After configuring the test-packet filter settings and the test-port settings, the configurer 33 notifies the determiner 32 of the completion of the settings configuration. Then, the determiner 32 generates a test packet and forwards the test packet to the start port via the transmitter 22. In the example in FIG. 8, the test packet is inputted to the port 1 of the switch SW1. The determiner 32 records the time of the transmission of the test packet.

If the switch SW1 processes a packet according to the configured setting, a packet inputted to the switch SW1 through the port 1 is outputted from the switch SW1 through the port 2 and arrives at the port 3 of the switch SW0. Since no filter is applied to the port 3 of the switch SW0 to block input of test packets, the switch SW0 receives the test packet and passes it to the port 4. Since no filter is applied to the port 4 to block output of test packets, the test packet is outputted through the port 4 and arrives at the port 5 of the switch SW2. The switch SW2 receives the test packet inputted through the port 5 and outputs the test packet through the test port TP. In this way, if the switch SW1, the switch SW2, and the ports 3 and 4 of the switch SW0 forward the test packet according to their configured settings, the test packet arrives at the test port TP via the forwarding route denoted by arrow A11 and arrow A12 in FIG. 8. The test packet outputted through the test port TP is forwarded to the control apparatus 20. Thus, after transmitting the test packet, the control apparatus 20 receives the test packet if the switch SW1, the switch SW2, and the ports 3 and 4 of the switch SW0 forward the test packet according to the configured settings.

Upon receipt of the test packet, the receiver 23 of the control apparatus 20 outputs the test packet to the determiner 32. If receiving the test packet within a predetermined period of time after the transmission of the test packet, the determiner 32 determines that the switches in the tested area are forwarding packets via the assumed route. In the example in FIG. 8 for instance, if the test packet is received within a predetermined period of time after the transmission of the test packet, the determiner 32 determines that the switch SW1, the switch SW2, and the ports 3 and 4 of the switch SW0 are forwarding packets according to the configured settings. If, on the other hand, the test packet is not received within the predetermined period of time after the transmission of the test packet in the example in FIG. 8, the determiner 32 determines that at least one of the switch SW1, the switch SW2, and the ports 3 and 4 of the switch SW0 is not forwarding packets according to the configured settings. The determiner 32 records the determination result as the test result 45 and notifies the test controller 31 of the determination result.

When notified that the forwarding processing is not performed according to the configured settings, the test controller 31 ends the test and transmits, via the transmitter 22, the test result to the terminal manipulated by the operator. Descriptions of the test ending processing and the like will be given later.

On the other hand, when notified that the forwarding processing is performed according to the configured settings, the test controller 31 determines the next tested area. Specifically, the test controller 31 determines the next tested area so that the next tested area may include the area for which it has been determined that packets are forwarded according to the configured settings and so that forwarding processing at the flow switch for which it is yet to be determined whether the forwarding processing is performed according to the configured settings may not be performed more than once. For instance, if it is determined as a result of the test in FIG. 8 that the forwarding is performed according to the configured settings, it is yet to be determined whether packets are forwarded according to the configured settings at the ports 9, 10, 15, and 16 of the switch SW0 operating as a flow switch. Thus, the test controller 31 determines that forwarding from the port 9 to the port 10 of the switch SW0 is to be included to determine whether this forwarding processing is performed according to the configured settings. For example, assume that the test controller 31 sets the end port of the tested area at the port 11 of the switch SW4. Then, the test controller 31 notifies the configurer 33 and the determiner 32 that the tested area is from the port 1 of the switch SW1 to the port 11 of the switch SW4.

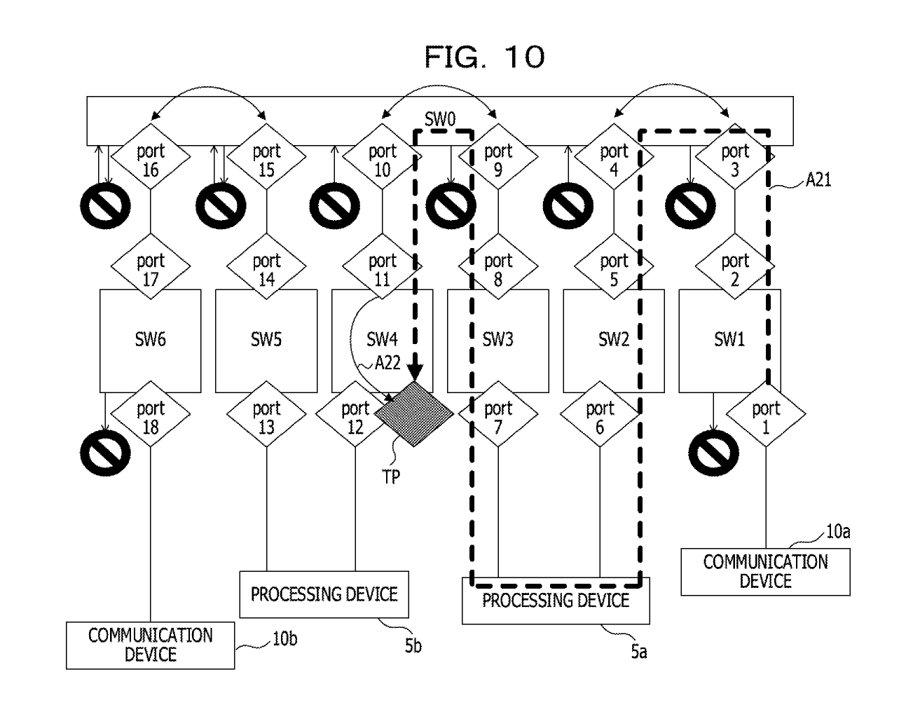

FIG. 10 is a diagram illustrating an example of processing for checking the connectivity of the forwarding route in the area from the switch SW1 to the switch SW4. Upon acquisition of information on the next connectivity tested area from the test controller 31, the configurer 33 removes the test port used for the previous tested area from the port 1 of the switch SW0 to the port 5 of the switch SW2, and sets a new test port at the switch SW4. In this regard, the configurer 33 requests the switch SW2 to cancel the test-port forwarding setting (the forwarding setting denoted by arrow A12 in FIG. 8). In addition, using the switch configuration table 41, the port configuration table 42, and the filter table 44, the configurer 33 determines to remove the filters for blocking input of test packets through the port 9 of the switch SW0 and output of test packets through the port 10 of the switch SW0. Consequently, the concerned ports are filtered and the new test port is set as depicted in FIG. 10. Specifically, in the example in FIG. 10, the switch SW0 is configured as follows.

Processing Rule 1

destination MAC address=MACtest, and input port=virtual port 3 Condition 1:

Action: Output packet that satisfies Condition 1 through virtual port 4.

Processing Rule 2

destination MAC address=MACtest, and input port=virtual port 9 Condition 2:

Action: Output packet that satisfies Condition 2 through virtual port 10.

Processing Rule 3

destination MAC address=MACtest, and input port=virtual port 4, 10, 15, or 16 Condition 3:

Action: Not receive but drop packet that satisfies Condition 3

Processing Rule 4.

destination MAC address=MACtest, and output port=virtual port 3, 9, 15, or 16 Condition 4:

Action: Not transmit but drop packet that satisfies Condition 4.

The configurer 33 updates the filter table 44 in accordance with the changes on the filters applied to the switch SW0. Also in this case, packets other than test packets are forwarded via the route defined in the switch configuration table 41 and the port configuration table 42 in FIG. 7.

In FIG. 10, broken-line arrow A21 denotes the current tested area of the route R1. After setting the test port (TP) at the switch SW4, the configurer 33 configures the switch SW4 so that a test packet inputted to the switch SW4 through the port 11, which is the end port, may be forwarded to the test port. For example, the configurer 33 configures the switch SW4 as follows.

destination MAC address=MACtest, and input port=virtual port 11 Condition:

Action: Output packet that satisfies the above condition through test port TP.

Arrow A22 denotes the route via which the test packet is forwarded from the port 11 to the test port.

After configuring the test-packet filter settings and the test-port settings, the configurer 33 notifies the determiner 32 of the completion of the settings configuration. Then, the determiner 32 generates a test packet, transmits the test packet to the port 1 of the switch SW1 via the transmitter 22, and records the time of the transmission of the test packet.

By the time the test in FIG. 10 is performed, it has already been confirmed as a result of the test in FIG. 8 that packets are forwarded via the assumed route by the switch SW1, the switch SW2, and the ports 3 and 4 of the switch SW0. Thus, the test packet arrives at the port 5 of the switch SW2 at least.

If the test packet is forwarded according to the configured settings after the confirmed route, the test packet inputted to the switch SW2 through the port 5 is outputted from the switch SW2 through the port 6 and arrives at the port 7 of the switch SW3 via the processing device 5a. The test packet inputted to the switch SW3 through the port 7 is outputted from the switch SW3 through the port 8 and arrives at the port 9 of the switch SW0. Since no filter is applied to the port 9 of the switch SW0 to block input of test packets, the switch SW0 receives the test packet and passes it to the port 10. Since no filter is applied to the port 10 to block output of test packets, the test packet is outputted through the port 10 and arrives at the port 11 of the switch SW4.

The switch SW4 receives the test packet inputted thereto through the port 11 and outputs the test packet through the test port TP. In this way, if the switches SW1 to SW4 and the ports 3, 4, 9, and 10 of the switch SW0 forward the test packet according to their configured settings, the test packet arrives at the test port TP via the forwarding route denoted by arrows A21 and A22 in FIG. 10. The packet outputted through the test port TP is forwarded to the control apparatus 20. Thus, after transmitting the test packet, the control apparatus 20 receives the test packet if the switches SW1 to SW4 and the ports 3, 4, 9, and 10 of the switch SW0 forward the test packet according to the configured settings.

Upon receipt of the test packet, the receiver 23 of the control apparatus 20 outputs the test packet to the determiner 32. If receiving the test packet within the predetermined period of time after the transmission of the test packet, the determiner 32 determines that the switches SW1 to SW4 and the ports 3, 4, 9, and 10 of the switch SW0 forward packets according to the configured settings. The determiner 32 records the determination result as the test result 45 and notifies the test controller 31 of the determination result.

When notified that the forwarding processing is performed according to the configured settings, the test controller 31 sets the next tested area so that forwarding processing at the flow switch for which it is yet to be determined whether the forwarding processing is performed according to the configured settings may not be performed more than once. For instance, if it is determined as a result of the test in FIG. 10 that the forwarding is performed according to the configured settings, it is yet to be determined whether packets are forwarded according to the configured settings at the ports 15 and 16 of the switch SW0 operating as a flow switch. Thus, in this example, the test controller 31 determines that forwarding from the port 15 to the port 16 of the switch SW0 is to be included to determine whether this forwarding processing is performed according to the configured settings, and sets the end port of the tested area at the port 17 of the switch SW6. Then, the test controller 31 notifies the configurer 33 and the determiner 32 of the new tested area.

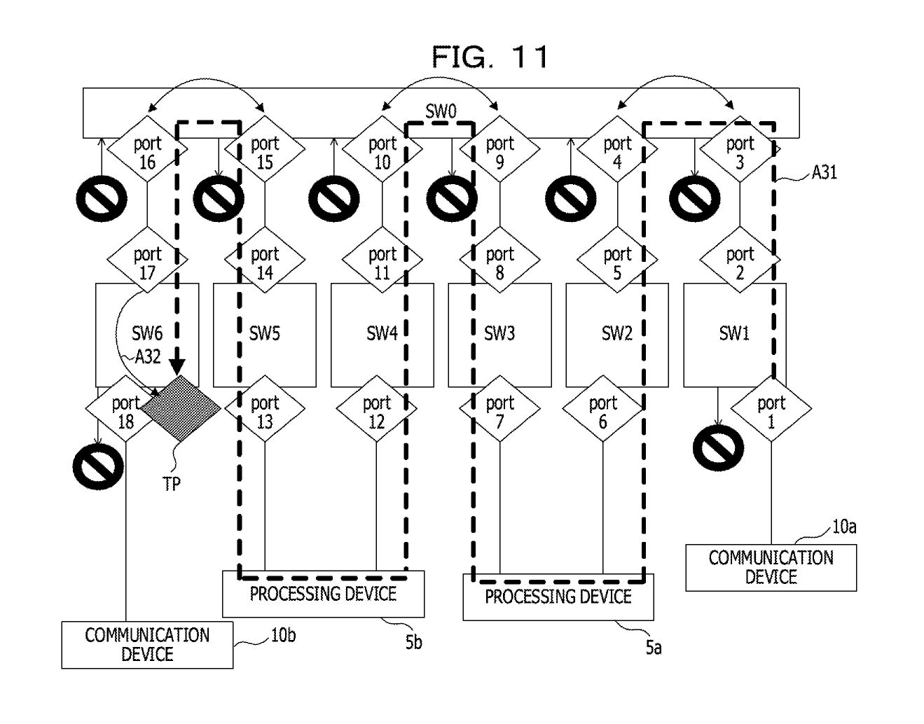

FIG. 11 is a diagram illustrating an example of processing for checking the connectivity of the forwarding route in the area from the switch SW1 to the switch SW6. Upon acquisition of information on the next connectivity tested area from the test controller 31, the configurer 33 removes the test port used for the previous tested area from the port 1 of the switch SW0 to the port 11 of the switch SW4, and sets a new test port at the switch SW6. In this regard, the configurer 33 requests the switch SW4 to cancel the test-port forwarding setting (the forwarding setting denoted by arrow A22 in FIG. 10). In addition, using the switch configuration table 41, the port configuration table 42, and the filter table 44, the configurer 33 determines to remove the filters for blocking input of test packets through the port 15 of the switch SW0 and output of test packets through the port 16 of the switch SW0. Consequently, the concerned ports are filtered and the new test port is set as depicted in FIG. 11. Specifically, in the example in FIG. 11, the switch SW0 is configured as follows.

Processing Rule 1

destination MAC address=MACtest, and input port=virtual port 3 Condition 1:

Action: Output packet that satisfies Condition 1 through virtual port 4.

Processing Rule 2

destination MAC address=MACtest, and input port=virtual port 9 Condition 2:

Action: Output packet that satisfies Condition 2 through virtual port 10.

Processing Rule 3

destination MAC address is MACtest, and input port=virtual port 15 Condition 3:

Action: Output packet that satisfies Condition 3 through virtual port 16.

Processing Rule 4

destination MAC address=MACtest, and input port=virtual port 4, 10, or 16 Condition 4:

Action: Not receive but drop packet that satisfies Condition 4.

Processing Rule 5

destination MAC address=MACtest, and output port=virtual port 3, 9, or 15 Condition 5:

Action: Not transmit but drop packet that satisfies Condition 5.

The configurer 33 updates the filter table 44 in accordance with the changes on the filters applied to the switch SW0.

In FIG. 11, broken-line arrow A31 denotes the current tested area of the route R1. After setting the test port (TP) at the switch SW6, the configurer 33 configures the switch SW6 so that a test packet inputted to the switch SW6 through the port 17, which is the end port, may be forwarded to the test port. For example, the configurer 33 configures the switch SW6 as follows.

destination MAC address=MACtest, and input port=virtual port 17 Condition:

Action: Output packet that satisfies the above condition through test port TP.

Arrow A32 denotes the route via which the test packet is forwarded from the port 17 to the test port.

By the time the test in FIG. 11 is performed, it has already been confirmed as a result of the tests in FIGS. 8 and 10 that packets are forwarded via the assumed route by the switches SW1 to SW4 and the ports 3, 4, 9, and 10 of the switch SW0. Thus, the test packet arrives at the port 11 of the switch SW4 at least.

If the test packet is forwarded according to the configured settings after the confirmed route, a packet inputted to the switch SW4 through the port 11 is outputted from the switch SW4 through the port 12 and arrives at the port 13 of the switch SW5 via the processing device 5b. The packet inputted to the switch SW5 through the port 13 is outputted from the switch SW5 through the port 14 and arrives at the port 15 of the switch SW0. Since no filter is applied to the port 15 of the switch SW0 to block input of test packets, the switch SW0 receives the test packet and passes it to the port 16. Since no filter is applied to the port 16 to block output of test packets, the test packet is outputted through the port 16, and arrives at the port 17 of the switch SW6.

The switch SW6 receives the test packet inputted thereto through the port 17 and outputs the test packet through the test port TP. In this way, if the switches SW1 to SW6 and all the ports of the switch SW0 forward the test packet according to their configured settings, the test packet arrives at the test port TP via the forwarding route denoted by arrows A31 and A32 in FIG. 11. The packet outputted through the test port TP is forwarded to the control apparatus 20. Thus, after transmitting the test packet, the control apparatus 20 receives the test packet if the switches SW0 to SW6 forward the test packet according to the configured settings.

Upon receipt of the test packet, the receiver 23 of the control apparatus 20 outputs the test packet to the determiner 32. If receiving the test packet within a predetermined period of time after the transmission of the test packet, the determiner 32 determines that the switches SW0 to SW6 forward packets according to the configured settings. The determiner 32 records the determination result as the test result 45 and notifies the test controller 31 of the determination result.

The test controller 31 determines whether the flow switch has ports for which it is yet to be determined whether forwarding processing is performed at the ports according to the configured setting. After the test in FIG. 11, the flow switch does not have any ports for which it is yet to be determined whether forwarding processing is performed at the ports according to the configured setting. Thus, the test controller 31 determines to end the test. A detailed description of the test ending processing will be given later.

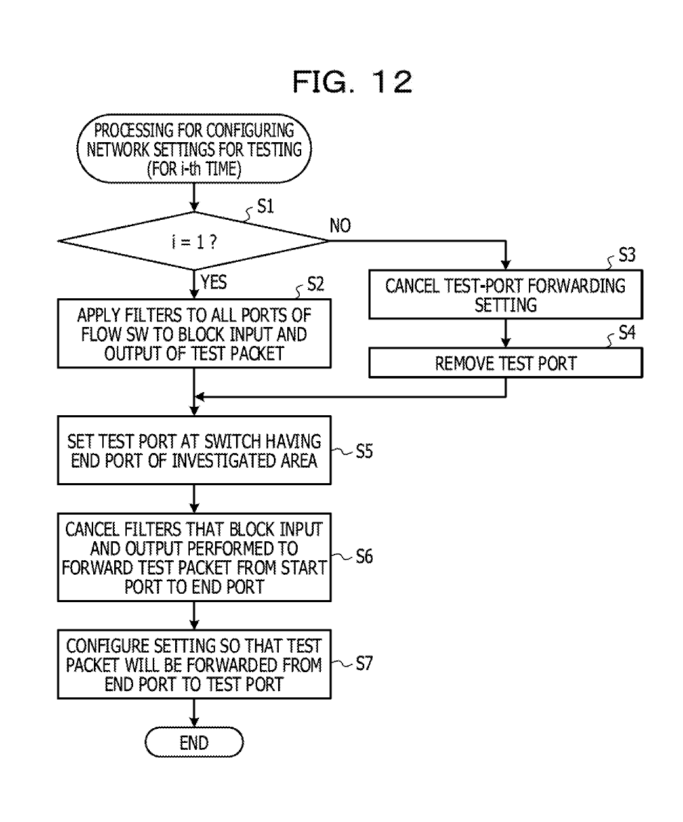

FIG. 12 is a flowchart illustrating an example of network configuration processing. In FIG. 12, a variable i is used to count the number of tests performed on a given tested route. Note that the processing in FIG. 12 is just an example, and depending on the implementation, the order of the steps of the procedure may be changed. For instance, Step S3 and Step S4 may be reversed in order.

When notified by the test controller 31 of a tested area of a tested route, the configurer 33 determines whether the variable i, indicative of the number of tests performed on the tested route, is 1 (Step S1). If the variable i is 1 (Yes in Step S1), meaning that it is the first test, the configurer 33 applies filters to all the ports of the flow switch to block input and output of test packets (Step S2). If the variable i is not 1 (No in Step S1), meaning that it is the second or subsequent test, the configurer 33 cancels the current test-port forwarding setting (Step S3) and removes the current test port (Step S4). The processing in Steps S3 and S4 are implemented when the configurer 33 sends a control message to the switch having the test port, so that the switch may change the settings. After the processing in Step S2 or Step S4, the configurer 33 sets a test port at the switch having the end port of the tested area (Step S5). The configurer 33 removes the filters that block input and output performed to forward a test packet from the start port to the end port (Step S6). The configurer 33 also configures the test-port forwarding setting so that a test packet may be forwarded from the end port to the test port (Step S7).

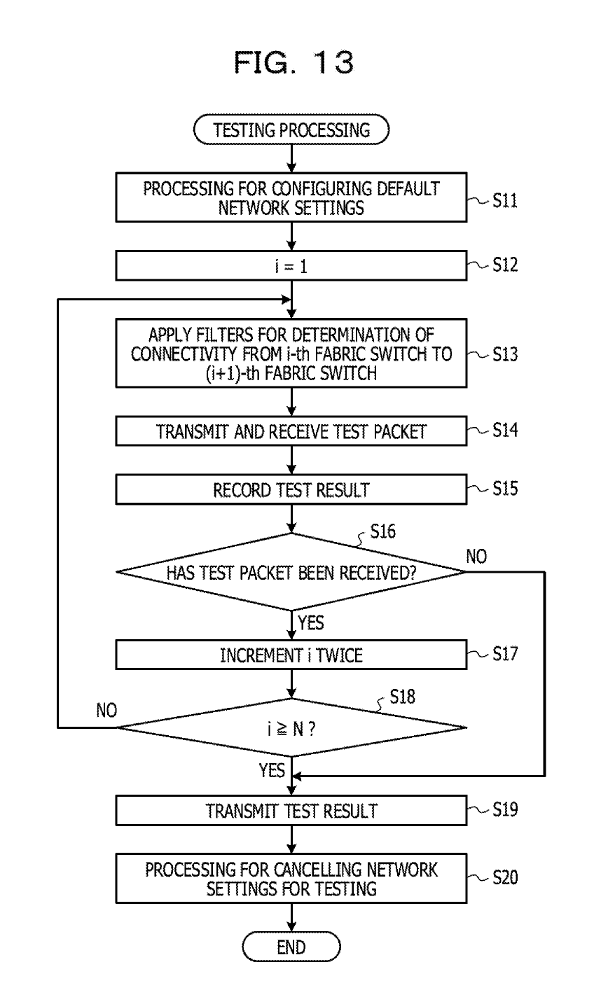

In the procedure illustrated in FIG. 12, filters for blocking input and output of test packets are applied to all the ports of the flow switch first, and then, the filters on the tested area of the forwarding route are removed. This is just an example. Instead, for example, the configurer 33 may first identify the ports to be traversed by a test packet and the directions in which the test packet traverses the ports (output or input), and then apply filters to the ports not to be used during the forward processing so that the ports will block input or output of test packets. The flowchart illustrated in FIG. 13 may be modified in the same manner.

FIG. 13 is a flowchart illustrating an example of a connectivity check test. In FIG. 13, a variable i is used to identify a tested area. In FIG. 13, a constant N represents the number of fabric switches in the network.

Before the test is started, the configurer 33 applies input/output blocking filters to all the ports of the flow switch as the default network settings (Step S11). Then, the test controller 31 sets the variable i to 1 (Step S12). The configurer 33 applies filters to determine the connectivity of the area from the switch having the start port to the (i+1)-th fabric switch (Step S13). Specifically, in Step S13, out of the filters applied in Step S11, the configurer 33 removes the ones which are applied to the ports on the forwarding route in the area from the switch having the start port to the (i+1)-th fabric switch and which would otherwise block a test packet forwarded in the forwarding route.

After that, the determiner 32 transmits a test packet to the start port and then receives the test packet back from the test port if the test packet is inputted thereto from the test port (Step S14). If the test packet is not inputted to the determiner 32 from the test port within a predetermined period of time, the determiner 32 waits for the test packet until a timeout. The determiner 32 determines whether the test packet has flowed through the tested area (the connectivity) based on whether the determiner 32 receives the test packet, and records the obtained determination result in the test result 45 (Step S15). The test controller 31 determines whether the determiner 32 successfully receives the test packet in Step S14 (Step S16). If the determiner 32 successfully receives the test packet (YES in Step S16), the test controller 31 determines that the test packet has flowed through the tested area. Then, the test controller 31 increments the variable i twice (Step S17) and determines whether or not the variable i is equal to or larger than the constant N (Step S18). If the variable i is not equal to or larger than the constant N (No in Step S18), the test controller 31 proceeds back to Step S13 to repeat the processing from there. If the variable i is equal to or larger than the constant N (Yes in Step S18), the test controller 31 determines that connectivity has been confirmed for the entire tested route, and transmits the test result to the terminal manipulated by the operator (Step S19). The configurer 33 cancels the network settings configured for testing (Step S20), and the processing ends.

If, on the other hand, the determiner 32 does not successfully receives the test packet (No in Step S16), it represents that the test packet has not flowed through the tested area (No in Step S16). Thus, the test controller 31 ends the test and transmits the test result 45 to the operator's terminal (Step S19). In this regard, among the tested areas, the failure location specifier 35 specifies the area the connectivity of which has not been confirmed by the tests, as a possible location of failure, and transmits the failure information to the operator's terminal along with the test result 45. After that, the configurer 33 cancels the network settings for testing (Step S20), and the processing is ended.

(3) Evaluation of Test Results

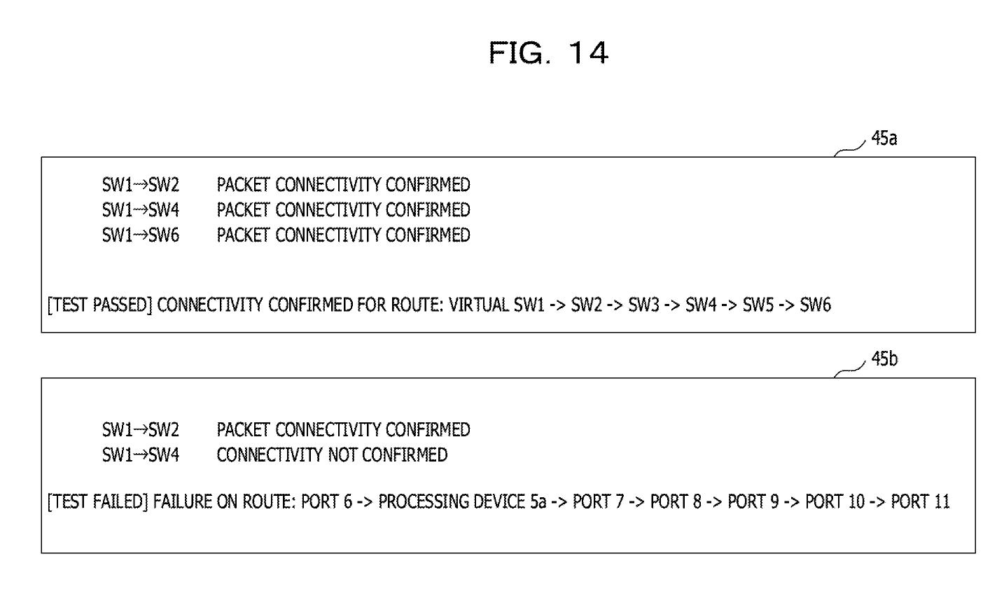

FIG. 14 is a diagram illustrating an example of the test result 45. A test result 45a is an example of the test result 45 obtained in the case illustrated with reference to FIGS. 8 to 11. Information on the first line of the test result 45a indicates that the connectivity of the area from the switch SW1 to the switch SW2 has been confirmed using a test packet (hereinafter referred to as packet connectivity). This information is written by the determiner 32 as the test result 45 when the determiner 32 confirms the packet connectivity in the test described with reference to FIG. 8. Information on the second line of the test result 45a indicates that the test-packet connectivity of the area from the switch SW1 to the switch SW4 has been confirmed. This information is written by the determiner 32 as the result of the test described with reference to FIG. 10. Information on the third line of the test result 45a indicates that the test-packet connectivity of the area from the switch SW1 to the switch SW6 has been confirmed. This information is written by the determiner 32 as the result of the test described with reference to FIG. 11. If all the areas have passed the connectivity test, the test controller 31 adds, to the test result 45, information indicating that the test has succeeded. The test result 45a includes an indication that the route passed the test and the order of the fabric switches traversed by a test packet on the connectivity-confirmed route.

A test result 45b, on the other hand, is an example of the test result 45 in a case where the test in FIG. 8 is passed, but in the test in FIG. 10, the control apparatus 20 does not receive the test packet within the predetermined period of time after the transmission of the test packet. Information on the second line of the test result 45b indicates that the connectivity of the area from the switch SW1 to the switch SW4 has not been confirmed. This connectivity result is written by the determiner 32 in the test result 45b when the determiner 32 does not receive the test packet within the predetermined period of time after the transmission of the test packet. If the determiner 32 determines that the packet connectivity test has been failed, the test controller 31 ends the test. Then, the failure location specifier 35 specifies a possible location of failure in the route the connectivity test for which has been failed, by excluding the area that has passed the packet connectivity test from the entire route. The test controller 31 records, in the test result 45b, an indication that the test has been failed and information on the area specified by the failure location specifier 35. In the area denoted by arrow A21 in FIG. 10, the area excluding the area the connectivity of which has been confirmed by the test in FIG. 8 (the area denoted by arrow A11) is specified as a possible location of failure in the test result 45b. Specifically, it is specified that the network has a failure somewhere in the section from the port 6 to the port 11 via the processing device 5a, the port 7, the port 8, the port 9, and the port 10.

The test controller 31 transmits, via the transmitter 22, the obtained test result 45 to the terminal used by the operator. This allows the operator to determine, using the test result 45 transmitted to the terminal, whether packets are forwarded in the assumed route. Further, notifying the operator that packets are not forwarded in the assumed route with information such as the test result 45b allows the operator to check the settings for the section specified in the test result 45b as a possible section of failure.

(4) Test Ending Processing

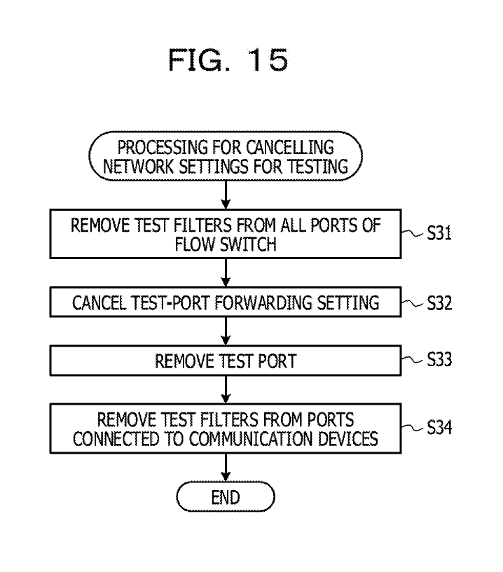

FIG. 15 is a flowchart illustrating an example of processing for cancelling the settings for testing. The processing in FIG. 15 is just an example, and the order of the Steps S31 to S34 may be changed appropriately. The configurer 33 removes the test filters from all the ports of the flow switch (Step S31). The configurer 33 cancels the test-port forwarding setting (Step S32). The configurer 33 removes the test port (Step S33). The configurer 33 removes the test filters from the ports connected to the communication devices 10 (Step S34).

As described above, the method according to the first embodiment conducts the connectivity check by blocking input and output of a test packet which are not performed if the test packet is forwarded from the start port to the end port of the connectivity check area via the expected forwarding route. It is therefore possible to determine whether the test packet has been forwarded via the expected forwarding route. Not only connectivity but also the order of the switches traversed by a test packet is checkable only by applying test-packet filters to the flow switch and setting a test port at a fabric switch. Hence, the test according to the first embodiment is simple and easy. The method according to the first embodiment is advantageous in terms of testing cost because the connectivity check does not use any hardware specific for the testing.

In the first embodiment, when it is determined that a test packet has not been forwarded via the expected forwarding route, information on a location causing the test packet not to be forwarded via the expected route is transmitted as the test result 45 to the terminal used by the operator. When notified that packets are not forwarded via the assumed route, the operator may check, for example, the settings for the section notified of by the test result 45 as a possible section of failure. This facilitates and simplifies network maintenance.

<Modification>

As a modification of the first embodiment, a case is described in which connectivity of the reversed route of the route R1 (FIG. 6) is tested in a network having the communication device 10b on the flow's start point side and the communication device 10a on the flow's end point side. This case is processed in the same manner as in the first embodiment, except that the start port is set at one of the ports of the switch SW6 which is connected to the communication device 10b. Thus, to test the connectivity of the reverse route of the route R1, the test controller 31 first tests the forwarding route in the area from the switch SW6 to the switch SW5.

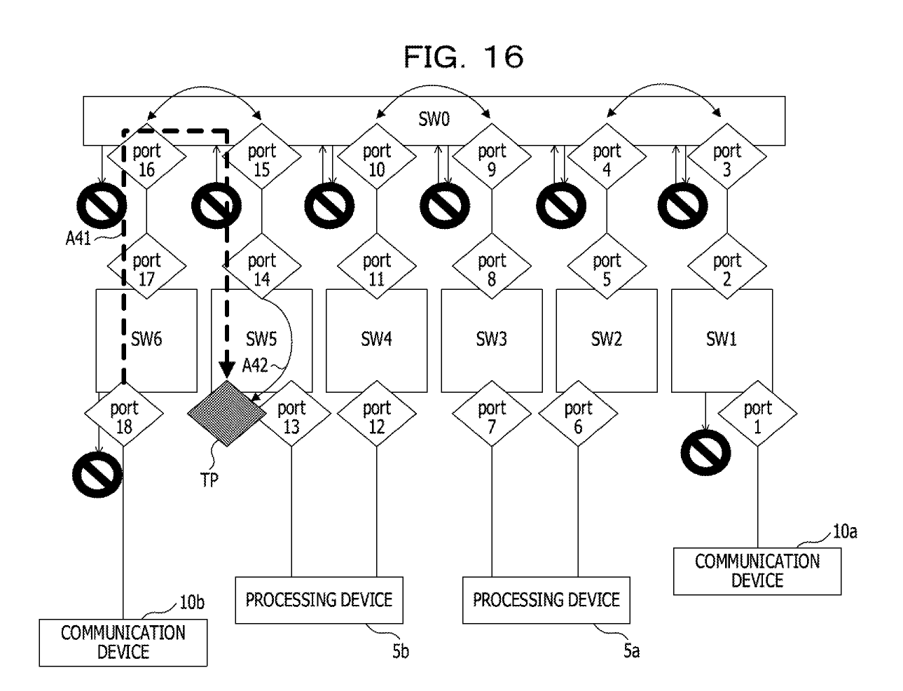

FIG. 16 is a diagram illustrating an example of processing for checking the connectivity of the forwarding route in the area from the switch SW6 to the switch SW5. To check the connectivity of the forwarding route from the switch SW6 to the switch SW5, all the forwarding paths in the switch SW0 for a test packet except for the one from the port 16 to the port 15 are invalidated by filtering. Consequently, input and output of test packets are blocked by the filtering at the ports 3, 4, 9, and 10 of the switch SW0. In addition, output of test packets through the port 16 and input of test packets through the port 15 are also blocked by filtering. Additionally, a test port is set at the switch SW5, and the switch SW5 is configured so that a packet inputted through the port 14 will be forwarded to the test port (as denoted by arrow A42). Processing regarding the filter settings and the test-port forwarding setting are performed in the same manner as in the first embodiment. By thus configuring the filter settings and the test-port forwarding setting, the configurer 33 defines a route for which to determine whether packets are forwarded via the route denoted by arrow A41.

After the configurer 33 completes the configuration processing, the determiner 32 transmits a test packet to the port 18, which is the start port, and determines whether the test packet is received back from the test port. If the determiner 32 successfully receives the test packet in the example in FIG. 16, the test controller 31 sets the second tested area to the area from the switch SW6 to the switch SW3.

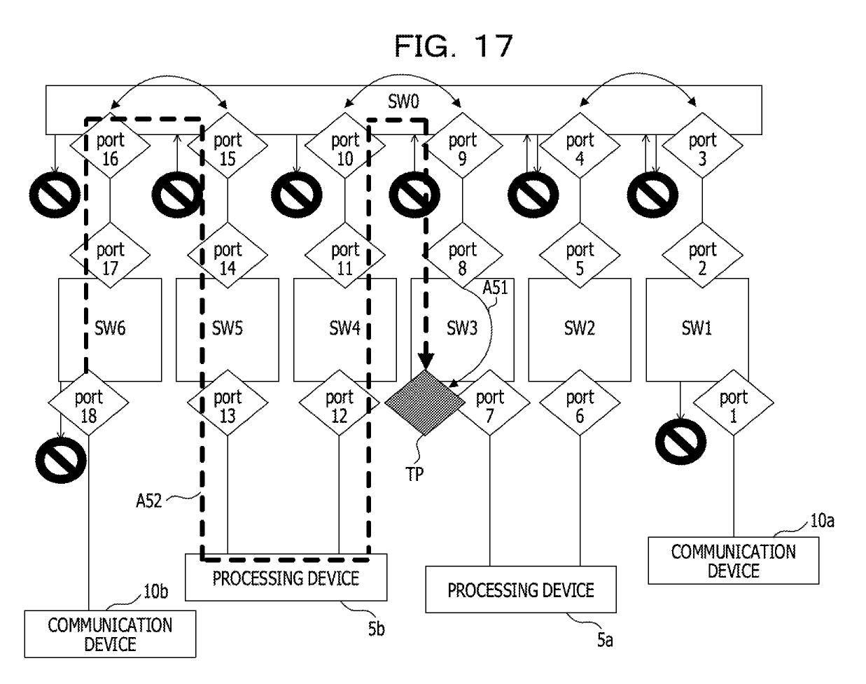

FIG. 17 is a diagram illustrating an example of processing for checking the connectivity of the forwarding route in the area from the switch SW6 to the switch SW3. To check the connectivity of the forwarding route from the switch SW6 to the switch SW3, filters are applied to the ports 3 and 4 of the switch SW0 to block input and output of test packets. In addition, filters are applied to block output of test packets through the port 16 and the port 10 and to block input of test packets through the port 15 and the port 9. The configurer 33 removes the test port set at the switch SW5 and also cancels the test-port forwarding setting in the switch SW5. Then, the configurer 33 sets a new test port at the switch SW3, and configures the switch SW3 so that test packets inputted thereto through the port 8 will be forwarded to the test port (as noted by arrow A51). By thus configuring the filter settings and the test-port forwarding setting, the configurer 33 defines a route for which to determine whether packets are forwarded via the route denoted by arrow A52.

After the configurer 33 completes the above configuration processing, the determiner 32 transmits a test packet to the port 18, which is the start port, and determines whether the test packet is received back from the test port. If the determiner 32 successfully receives the test packet again in the case in FIG. 17, the test controller 31 sets the third tested area to the area from the switch SW6 to the switch SW1.

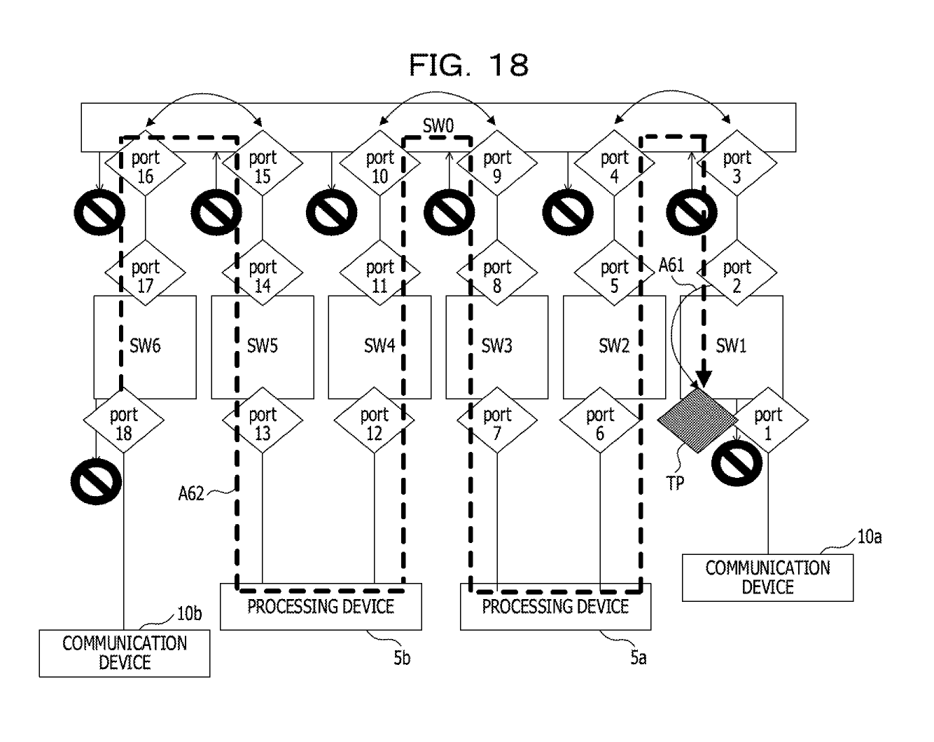

FIG. 18 is a diagram illustrating an example of processing for checking the connectivity of the forwarding route in the area from the switch SW6 to the switch SW1. To check the connectivity of the forwarding route from the switch SW6 to the switch SW1, filters are applied to the ports 16, 10, and 4 of the switch SW0 to block output of test packets through these ports, while filters are applied to the ports 15, 9, and 3 of the switch SW0 to block input of test packets through these ports. The configurer 33 removes the test port set at the switch SW3, and cancels the test-port forwarding setting in the switch SW3. The configurer 33 sets a new test port at the switch SW1, and configures the switch SW1 so that test packets inputted thereto through the port 2 will be forwarded to the test port (as denoted by arrow A61). By thus configuring the filter settings and the test-port forwarding setting, the configurer 33 defines a route for which to determine whether packets are forwarded via the route denoted by arrow A62.

After the configurer 33 completes the configuration processing, the determiner 32 transmits a test packet to the port 18, which is the start port, and determines whether the test packet is received back from the test port. If the determiner 32 successfully receives the test packet again in the case in FIG. 18, the test controller 31 determines that packets are forwarded according to the configured settings via the reversed route of the route R1, as well.

### Second Embodiment

In the following example, the area of a possible location of failure is smaller than that in the first embodiment. This may be used in a network where there is a high possibility of failure.

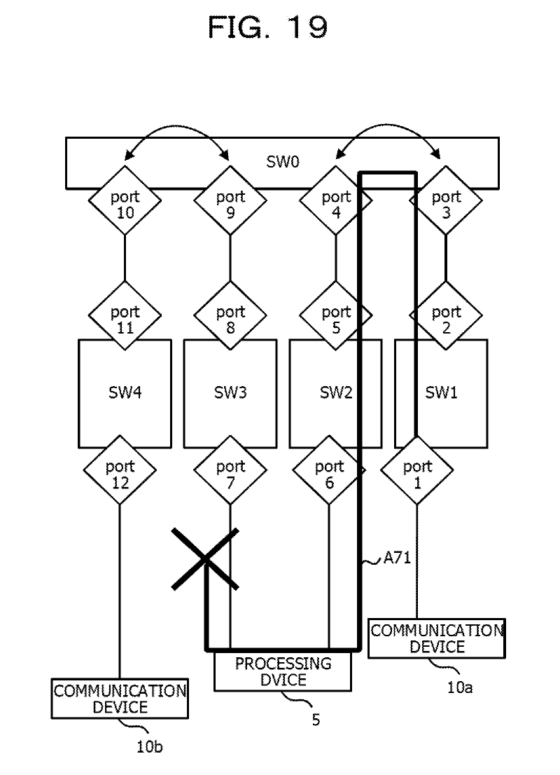

FIG. 19 is a diagram illustrating an example of a network having a failure. In the example described as the second embodiment, a virtual switch SW0 operates as a flow switch, and virtual switches SW1 to SW4 operate as fabric switches. The virtual switch SW0 is configured so that packets are forwarded between the port 3 and the port 4 and between the port 9 and the port 10. The port 1 of the switch SW1 is connected to the communication device 10a in this example. The port 6 of the switch SW2 and the port 7 of the switch SW3 are both connected to the processing device 5. The port 12 of the switch SW4 is connected to the communication device 10b. The port 2 of the switch SW1 is connected to the port 3 of the switch SW0, and the port 5 of the switch SW2 is connected to the port 4 of the switch SW0. The port 8 of the switch SW3 is connected to the port 9 of the switch SW0, and the port 11 of the switch SW4 is connected to the port 10 of the switch SW0. The network connections depicted in FIG. 19 are information identifiable from the switch configuration table 41, the port configuration table 42, and the topology information 46.

Assume that the network in FIG. 19 has a failure between the processing device 5 and the port 7 of the switch SW3. In this case, even though the route is defined to extend from the communication device 10a to the communication device 10b via the processing device 5, a packet is not inputted to the port 7 of the switch SW3, as depicted by arrow A71. Thus, a packet transmitted from the communication device 10a toward the communication device 10b does not reach the communication device 10b.

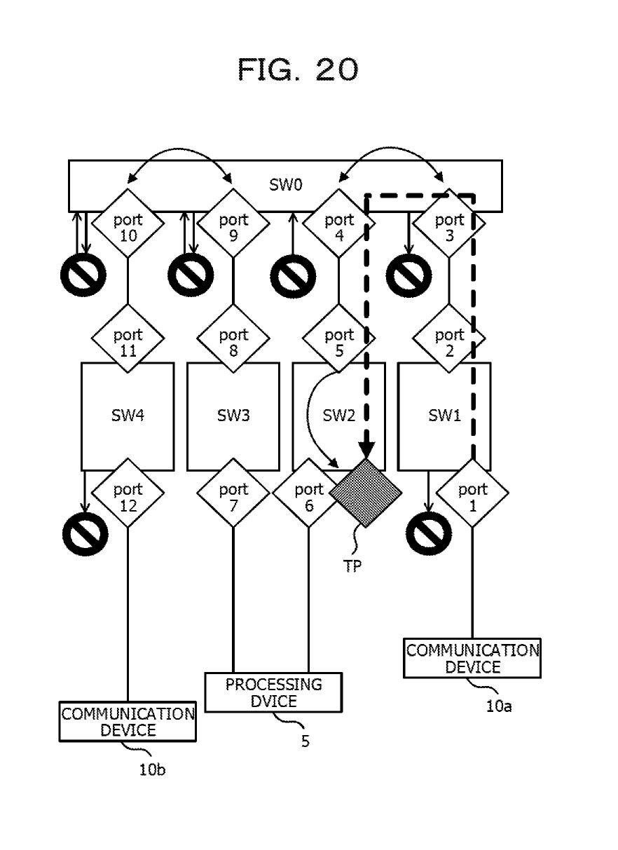

It is assumed here that test processing has been requested to locate the failure. Processing performed in the second embodiment, such as receiving a test request, is the same as that performed in the first embodiment. In the second embodiment, as in the first embodiment, when identifying the route for which the connectivity check test is requested, the test controller 31 applies filters to the flow switch, determining the area where only one route is possible. In this regard, the test controller 31 expands the test range by one adjacent fabric switch at a time. An example of this processing is described with reference to FIGS. 20 to 22.

FIG. 20 is a diagram illustrating an example of failure locating processing. For the first test, the test controller 31 determines to check the connectivity of the route from the start port to the fabric switch to which a packet is to be inputted after leaving the fabric switch having the start port. Specifically, the test controller 31 determines to check the connectivity from the port 1 of the switch SW1 to the port 5 of the switch SW2. The test controller 31 notifies the configurer 33 and the determiner 32 of the area targeted for the connectivity check processing. The configurer 33 applies filters in the same manner as in the first embodiment. Thus, the following processing rules are applied to the switch SW0 as filters. Note that the destination MAC address for a test packet in the second embodiment is also set to MACtest, and a packet is identified as a test packet based on its destination MAC address.

Processing Rule 1

destination MAC address=MACtest, and input port=virtual port 3 Condition 1:

Action: Output packet that satisfies Condition 1 through virtual port 4.

Processing Rule 2

destination MAC address=MACtest, and input port=virtual port 4, 9, or 10 Condition 2:

Action: Not receive but drop packet that satisfies Condition 2.

Processing Rule 3

destination MAC address=MACtest, and input port=virtual port 3, 9, or 10 Condition 3:

Action: Not transmit but drop packet that satisfies Condition 3.

The configurer 33 sets the test port TP at the switch SW2, and sets the following forwarding condition for the switch SW2.

destination MAC address=MACtest, and input port=virtual port 5 Condition:

Action: Output packet that satisfies the above condition through test port TP.

After configuring the test-packet filter settings and the test-port settings, the configurer 33 notifies the determiner 32 of the completion of the settings configuration. The determiner 32 then generates a test packet and inputs the test packet to the port 1 of the switch SW1, which is the start port, via the transmitter 22. It is assumed in this example that the determiner 32 then receives the test packet back from the test port via the receiver 23 within a predetermined period of time after the transmission of the test packet. The determiner 32 records the obtained determination result as the test result 45 and notifies the test controller 31 of the determination result.

Then, the test controller 31 sets the next tested area to an area combining the previously-tested area for which it has been determined that packets are forwarded according to the configured settings and an area from the fabric switch having the end port of the previously-tested area to the fabric switch to which a packet forwarded therefrom is to be inputted next. Thus, the test controller 31 determines to determine whether the network has a failure in the section from the port 1 of the switch SW1 to the port 7 of the switch SW3.

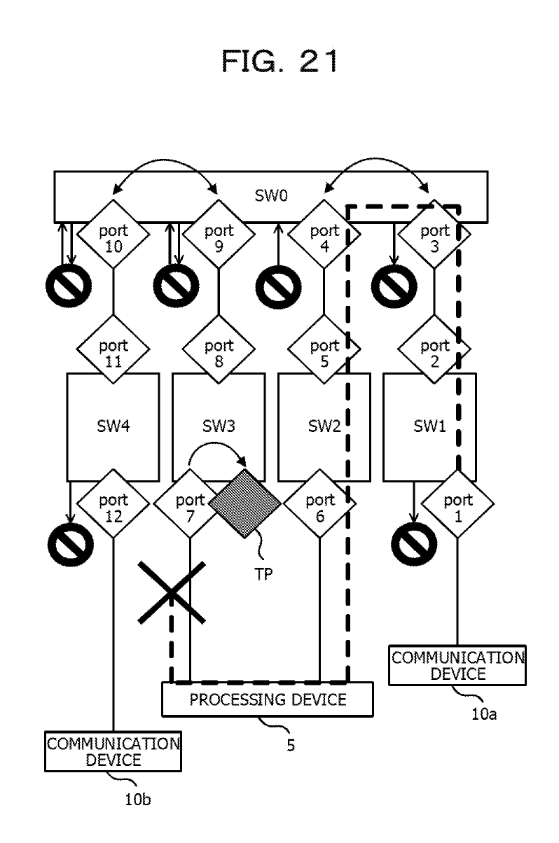

FIG. 21 is a diagram illustrating an example of processing for checking the connectivity of the forwarding route in the area from the switch SW1 to the switch SW3. The test controller 31 notifies the configurer 33 and the determiner 32 that the tested area is the section from the port 1 of the switch SW1 to the port 7 of the switch SW3. Using the switch configuration table 41, the port configuration table 42, and the topology information 46, the configurer 33 determines that the settings of the flow switch for the test of the newly determined area is the same as those for the previous test. Thus, the configurer 33 does not change the processing rules for the switch SW0.

Since the test port moves from the switch SW2 to the switch SW3 due to the change of the tested area, the configurer 33 removes the test port set at the switch SW2 and cancels the test-port forwarding setting in the switch SW2. The configurer 33 sets a test port at the switch SW3, and defines the following test-port forwarding processing rule for the switch SW3.

destination MAC address=MACtest, and input port=virtual port 7 Condition:

Action: Output packet that satisfies the above condition through test port TP.

After configuring the test-packet filter settings and the test-port settings, the configurer 33 notifies the determiner 32 of the completion of the settings configuration. The determiner 32 generates a test packet and inputs the test packet to the port 1 of the switch SW1, which is the start port, via the transmitter 22. By the time the test in FIG. 21 is conducted, it has already been confirmed by the test in FIG. 20 that packets are forwarded via the assumed route by the switches SW1 and SW2 and the ports 3 and 4 of the switch SW0. Thus, the test packet arrives at the port 5 of the switch SW2 at least. Assume that the test packet inputted to the processing device 5 from the port 6 and outputted from the processing device 5 is dropped due to a link failure between the processing device 5 and the port 7. Then, the control apparatus 20 does not receive the test packet within the predetermined period of time after the transmission of the test packet.

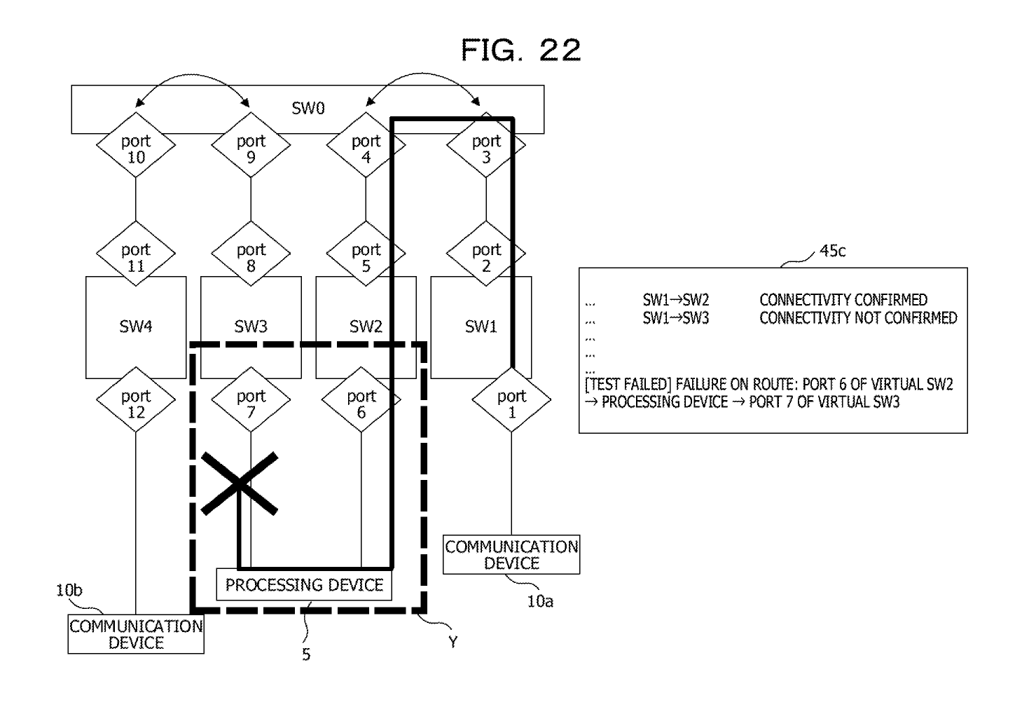

FIG. 22 is a diagram illustrating an example of processing for specifying a location of failure. As described using FIG. 21, if not acquiring a test packet within the predetermined period of time after the transmission of the test packet, the determiner 32 records, in a test result 45c, that the test of the connectivity from the switch SW1 to the switch SW3 has been failed. Recorded on the first line of the test result 45c is an indication that the connectivity from the switch SW1 to the switch SW2 has passed the test in the processing described with reference to FIG. 20.

After determining that the connectivity test has been failed, the test controller 31 ends the test. From the results recorded in the test result 45c, the failure location specifier 35 excludes the section that passed the test-packet connectivity test from the section that failed the test-packet connectivity test, and specifies the resultant section as a possible location of failure. Specifically, the failure location specifier 35 specifies the area within a broken-line rectangle Y in FIG. 22 as a possible location of failure. In the test result 45c, the test controller 31 records an indication that the test has failed and information on the area specified by the failure location specifier 35. Thus, it is specified from the test result 45c that the network has a failure somewhere in the section from the port 6 to the port 7 via the processing device 5. In this way, the second embodiment narrows down the section possibly having a failure, compared to the first embodiment.

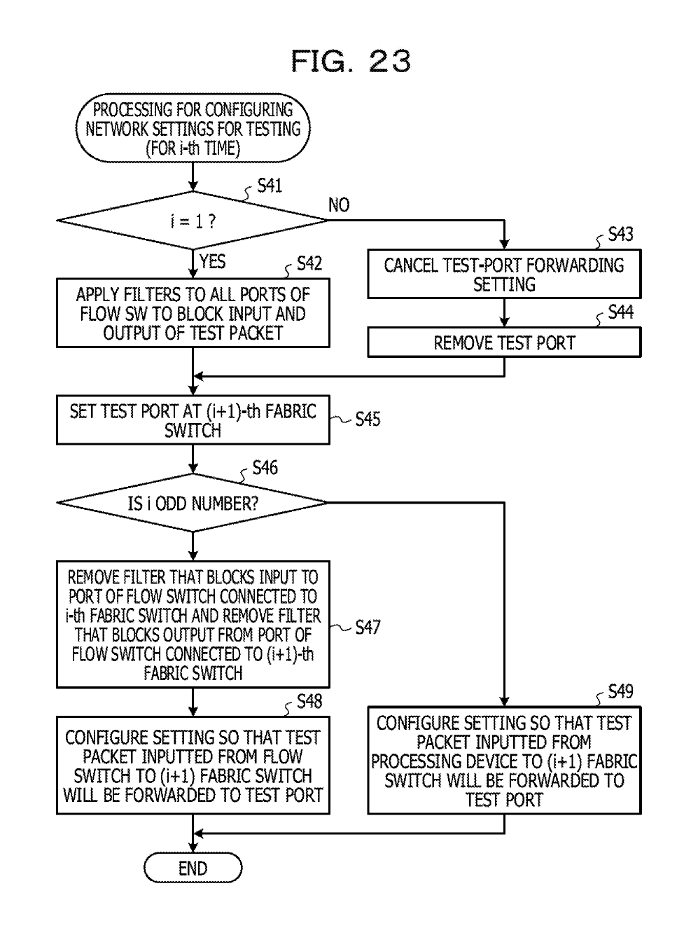

FIG. 23 is a flowchart illustrating an example of processing for checking the connectivity by expanding the tested area by one adjacent switch. Steps S41 to S44 are the same as Steps S1 to S4 described with reference to FIG. 12. The configurer 33 sets a test port at the (i+1)-th fabric switch (where i is the variable i) (Step S45). The configurer 33 determines whether the variable i is an odd number (Step S46). If the variable i is an odd number (Yes in Step S46), the configurer 33 removes, out of the filters applied to the flow switch, the one that blocks input of test packets through the port connected to the i-th fabric switch, and the one that blocks output of test packets through the port connected to the (i+1)-th fabric switch (Step S47). The configurer 33 configures the (i+1)-th fabric switch so that its port connected to the flow switch will forward test packets to the test port (Step S48).

If, on the other hand, the variable i is not an odd number (No in Step S46), the configurer 33 configures the (i+1)-th fabric switch so that its port connected to the processing device 5 will forward a test packet to the test port (Step S49).

When a possible location of failure is narrowed down as in the second embodiment, the area that has to be checked by the operator for the settings and the like may be reduced compared to the first embodiment, which facilitates and simplifies network management. Moreover, since filtering is performed in the second embodiment as well to keep test packets from being forwarded via a route other than the assumed route, not only is it possible to check for the connectivity, but also it is determinable whether the packet has traversed the switches and ports in the assumed order.

<Other Modifications>

The above embodiments are not restrictive, and may be modified variously. Examples of such modifications are given below.

Although the control apparatus 20 includes the failure location specifier 35 in the first and second embodiments, the control apparatus 20 does not have to. If the control apparatus 20 does not include the failure location specifier 35, the result of a connectivity test is recorded in the test result 45, but a possible location of failure is not specified in the test result 45. In this case, the operator finds out a possible location of failure by comparing the route via which a test packet has been received and the route via which a test packet has not been received.

If the control apparatus 20 includes an input device and an output device, the operator may use the input device of the control apparatus 20 to request a test, and then the control apparatus 20 may present the test result 45 to the operator by displaying the test result 45 of the test on the display of the output device.

The packet format and the tables used in the above descriptions are just an example. Information elements included in a packet or the tables may be changed appropriately depending on the implementation.

Moreover, depending on the implementation, the first embodiment and the second embodiment may be used in combination. For example, assume that a connectivity check for a particular route has failed. Then, the test controller 31 defines a new tested area by expanding the area that has passed the connectivity test to a switch newly established subsequent to the fabric switch having the end port of the area that has passed the connectivity test.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus that controls a plurality of packet forwarding devices, the control apparatus comprising:
a communication circuit configured to communicatively couple to the packet forwarding devices over a network; and
a processor coupled to the communication circuit and configured to
execute configuration processing that includes
applying filters for blocking input and output of a test packet to ports associated with the packet forwarding devices, except for one or more ports on an assumed forwarding route in a section targeted for a forwarding status determination, the section starting at a start port which is the port of the packet forwarding device located at a start of the section and ending at an end port which is the port of the packet forwarding device located at an end of the section, and
configuring the packet forwarding device located at the end port so that the test packet that arrives at the end port is forwarded to the control apparatus,
execute communication processing that includes transmitting the test packet from the communication circuit to the start port, and
execute determination processing that includes determining that packet forwarding is performed normally in the section, upon receipt of the test packet via the communication circuit after the transmission of the test packet.

2. The control apparatus according to claim 2,
wherein the processor is further configured to execute test control processing that includes
defining a first area in a target route for which it is to be determined whether packet forwarding is performed normally, the first area being a section where only one forwarding route is possible when the filters are applied, and
requesting the configuration processing to apply the filters for the first area, and
wherein the test control processing includes, when the determination processing determines that the packet forwarding is performed normally in the first area, defining a second area as a new target for a test using the test packet, the second area including the first area and a section of the target route where there is only one possible forwarding route for the test packet outputted from the first area.

3. The control apparatus according to claim 2,
wherein the processor is further configured to execute specification processing that includes, when the determination processing determines that packet forwarding is not performed normally in the second area, specifying a possible section of failure by excluding the first area from the second area.

4. The control apparatus according to claim 1,
wherein the configuration processing includes applying the filters to one of the packet forwarding devices which operates as a flow switch that relays packets transmitted and received between the other ones of the packet forwarding devices.

5. A testing method performed by a control apparatus configured to control a plurality of packet forwarding devices each including a port to input a packet and a port to output a packet, the method comprising:
executing, by a processor of the control apparatus, configuration processing that includes
applying filters for blocking input and output of a test packet to the ports of the packet forwarding devices, except for one or more ports on an assumed forwarding route in a section targeted for a forwarding status determination, the section starting at a start port which is the port of the packet forwarding device located at a start of the section and ending at an end port which is the port of the packet forwarding device located at an end of the section, and
configuring the packet forwarding device located at the end port so that the test packet that arrives at the end port is forwarded to the control apparatus;
executing, by the processor of the control apparatus, communication processing that includes transmitting the test packet from the communication circuit to the start port, and
executing, by the processor of the control apparatus, determination processing that includes determining that packet forwarding is performed normally in the section, upon receipt of the test packet via the communication circuit after the transmission of the test packet.

6. The testing method according to claim 5, further comprising:
defining a first area in a target route for which it is to be determined whether packet forwarding is performed normally, the first area being a section where only one forwarding route is possible when the filters are applied;
applying the filters for the first area; and
when the determination processing determines that the packet forwarding is performed normally in the first area, defining a second area as a new target for a test using the test packet, the second area including the first area and a section of the target route where there is only one possible forwarding route for the test packet outputted from the first area.

7. The testing method according to claim 6, further comprising:
when determining that packet forwarding is not performed normally in the second area, specifying a possible section of failure by excluding the first area from the second area.

8. The testing method according to claim 5, further comprising:
applying the filters to one of the packet forwarding devices which operates as a flow switch that relays packets transmitted and received between the other ones of the packet forwarding devices.

9. A communication system, comprising:
a plurality of packet forwarding devices each including a port to input a packet and a port to output a packet; and
a control apparatus configured to control the packet forwarding devices,
wherein the control apparatus is configured to
apply filters for blocking input and output of a test packet to the ports of the packet forwarding devices, except for one or more ports on an assumed packet forwarding route an area targeted for a forwarding status determination, the area starts at a start port and ends at an end port;
configure the packet forwarding device located at the end port so that the test packet that arrives at the end port is forwarded to the control apparatus;
transmit the test packet to the start port; and
determine that packet forwarding is performed normally in the area, upon receipt of the test packet via the communication circuit after the transmission of the test packet.

10. A non-transitory computer-readable storage medium storing a program that causes processor to execute a process, the process comprising:
executing, by a processor of the control apparatus, configuration processing that includes
applying filters for blocking input and output of a test packet to the ports of the packet forwarding devices, except for one or more ports on an assumed forwarding route in a section targeted for a forwarding status determination, the section starting at a start port which is the port of the packet forwarding device located at a start of the section and ending at an end port which is the port of the packet forwarding device located at an end of the section, and
configuring the packet forwarding device located at the end port so that the test packet that arrives at the end port is forwarded to the control apparatus;
executing, by the processor of the control apparatus, communication processing that includes transmitting the test packet from the communication circuit to the start port, and
executing, by the processor of the control apparatus, determination processing that includes determining that packet forwarding is performed normally in the section, upon receipt of the test packet via the communication circuit after the transmission of the test packet.
